(19) United States
(12) Patent Application Publication
(10) Pub. No.: US 2010/0070930 A1
(43) Pub. Date: Mar. 18, 2010

(54) Business document system

(76) Inventor: Gilles Thibault, Montreal (CA)

Correspondence Address: DOWELL & DOWELL P.C., 103 Oronoco St., Suite 220, Alexandria, VA, 22314, US

(21) Appl. No.: 12/585,142

(22) Filed: Sep. 4, 2009

Related U.S. Application Data
(60) Provisional application No. 61/094,239, filed on Sep. 4, 2008.

(51) Int. Cl. G06F 3/048

(52) U.S. Cl. 715/854

(57) ABSTRACT

A hierarchical organization of business documents, system and graphical user interface related thereto, allowing the efficient organization of business documents such as contracts and other legal documents. In a non-limiting example, three-tier organization is made possible, the first tier relating to major business function, the second to business tasks or processes and the last to individual business documents. The business documents may themselves be made up of hierarchical sections. Reference to particular portions of the hierarchy may take the form of a coordinate or address. A graphical user interface includes means of navigating through the hierarchy towards a particular business document.

### CROSS-REFERENCE TO RELATED APPLICATION

The present application claims the benefit under 35 U.S.C. §119(e) of U.S. Provisional Application Ser. No. 61/094,239, filed on Sep. 4, 2008 by Gilles THIBAULT, hereby incorporated by reference herein.

### FIELD OF THE INVENTION

The present invention relates to the field of electronic business document systems and more particularly to the field of business document organization systems.

### BACKGROUND OF THE INVENTION

Today, a large number of the documents pertaining to all aspects of a business are available in digital form for viewing or manipulating on a computer. These digital documents are typically stored on a computer or server within a company network by the individual who has created the document. In practice, however, many different individuals and parties within or associated to the particular business may need to have access to a given document. Current technologies fail to provide an efficient way to locate the document and to provide access to it to authorized individuals.

Furthermore, it is generally preferable in business to follow certain established standards consistently. With business documents of all types, it is often preferable to maintain a certain amount of consistency and to apply standardization of formats that are known to be acceptable. However, current business document solutions do not facilitate the application of business standards and often hinder the process.

Furthermore, it is a practice among businesses to purchase business documents in completed or template form from third party providers. However, the third party providers generally do not have access to the company's systems and cannot provide an integrated way to present their products.

In the context of the above, it can be appreciated that there is a need in the industry for a solution that overcomes the problems of the prior art.

### SUMMARY OF THE INVENTION

In accordance with a first broad aspect, the present invention provides

In accordance with a second broad aspect, the present invention provides a graphical user interface implemented on a computer, comprising: a first selection component allowing a user to select a root category among a plurality of root categories of a business documentation directory, each root category being associated with at least one business document class; a second selection component associated to a particular one of the root categories, the second selection component allowing a user to select a descendent category among a plurality of descendent categories, each descendent category being associated with a business document sub-class that is within the document class of the selected root category; a first visualisation component displayable upon selection of the particular one of the descendent categories to display individual document indicia, associated with respective documents within the business document sub-classes of the selected descendent category; each document indicia including a document indicium control allowing the user to cause display of the respective document.

In accordance with a third broad aspect, the present invention provides a system for organizing business documents comprising: a business directory comprising a plurality of business documents, the business directory comprising: a plurality of root categories each root category being associated with at least one business document class; and at least one set of descendent categories associated with a particular root category, each descendent category being associated with a business document subclass that is within the particular root category; a first selection tool for allowing a user to select a root category from among the plurality of root categories, the selected root category being associated with a set of descendent categories from among the at least one set of descendent categories; a second selection tool for allowing the user to select a descendent category from the set of descendent categories associated with the selected root category, the selected descendent category being associated with at least one business document from the plurality of business documents; and a third selection tool for allowing the user to select a business document from the at least one business document associated with the selected descendent category, selecting the business document causing the display of the business document to the user.

These and other aspects and features of the present invention will now become apparent to those of ordinary skill in the art upon review of the following description of specific embodiments of the invention and the accompanying drawings.

### BRIEF DESCRIPTION OF THE DRAWINGS

A detailed description of examples of implementation of the present invention is provided hereinbelow with reference to the following drawings, in which:

FIG. 1 is a block diagram representing apparatus for implementing a user interface in accordance with a non-limiting example of implementation;

FIG. 2 is a block diagram representing a network-based client-server system for implementing a system of hierarchical organization of business documents in accordance with a non-limiting embodiment;

FIG. 3A shows a general representation of a graphical user interface for the system in accordance with a non-limiting embodiment;

FIG. 3B shows various elements of the graphical user interface of FIG. 3A as used in retrieving business documents in accordance with a non-limiting example of implementation;

FIG. 3C shows a non limiting example of graphical user interface elements of the graphical user interface of FIG. 3A;

FIG. 3D shows a non limiting example of graphical user interface elements of the graphical user interface of FIG. 3A;

FIG. 3E shows various elements of the graphical user interface of FIG. 3A as used in accessing a business document template in accordance with a non-limiting example of implementation;

FIG. 3F shows a non-limiting example of an online store interface;

FIG. 4 shows a set of clickable controls for adding a business document to a hierarchical organization in accordance with a non limiting embodiment;

FIG. 5 shows graphical user interface elements for adding a business document for a business document to a hierarchical organization of business documents in accordance with a non-limiting embodiment;

FIG. 6 shows a flow chart depicting the steps involved in adding a new business document to a hierarchical organization of business documents in accordance with a non-limiting example of implementation;

FIG. 7 shows a set of editing tools for performing content modification tasks for a business document in accordance with a non-limiting embodiment;

FIG. 8 shows a non-limiting example of graphical user interface elements for editing the contents of a hierarchical organization of business documents;

FIG. 9 shows a non-limiting example of graphical user interface elements for editing the contents of a hierarchical organization of business documents;

FIG. 10A shows a non-limiting example of graphical user interface elements for implementing a content scheduler;

FIG. 10B is a diagram showing the access to the hierarchical organization of business documents by internal and external users;

FIG. 11A shows a non-limiting example of graphical user interface elements for implementing a clipboard interface in accordance with a non-limiting embodiment; and

FIG. 11B shows a non-limiting example of graphical user interface elements for confirming the deletion of a business document.

In the drawings, embodiments of the invention are illustrated by way of example. It is to be expressly understood that the description and drawings are only for purposes of illustration and as an aid to understanding, and are not intended to be a definition of the limits of the invention.

### DETAILED DESCRIPTION

In accordance with non-limiting embodiments of the present invention, there is provided a system of hierarchical organization of business documents.

According to a non-limiting definition, a business document refers to any documentation (or part thereof) that is organized using the system. As used here, the business document may refer to a single instance of such documentation and/or a plurality of instances of such documentation. Non-limiting examples of business documents may include:
Legal contracts, such as with those employees, suppliers, resellers and customers;
Intellectual Property-related documentation, such as patents;
Corporate communications, such as newsletters and press releases;
Financial statements, such as annual or quarterly balance sheets, income statements or Cost of Goods Sold statements;
Corporate policies and procedures, such as those in a Corporate Handbook; and/or
Technical communications, such as a User Guide for a product.

A hierarchy may refer to an arrangement of a set of elements (such as business documents, sections, categories, content, etc.) in a ranked or graduated series showing parent/child relationships between elements. For example, a set of business documents representing employee contracts could be organized into hierarchies based on when they were was hired, whether they manage other employees and the expected duration of their employment (e.g. full-time permanent employees, part-time permanent employees, and/or contract employees). These factors constitute a non-exhaustive list, as other possibilities remain and fall within the scope of the present invention.

When used as a noun, a non-limiting definition of the term hierarchical organization is identical to a hierarchy and the two terms may be used interchangeably. When this term is used as a verb, however, hierarchical organization refers to the process of organizing said set into an existing hierarchy. This process locates each member of the set within the hierarchy in relation to a superior element, to elements that are at the same level and to its descendant elements.

The system provides for hierarchical organization of a set of elements into the following three tiers:
First-tier elements (also referred to as “root categories”) are associated with major business functions, such as Compliance, Human Resources, Research and Development, and Intellectual Property;
Second-tier elements are associated with tasks and processes involved in providing the major business function identified in top tier, such as hiring practises, employment contracts, employee benefits and layoff/firing practises for Human Resources; and
Third-tier elements are associated with individual business documents involved in performing the actions identified with each task or process identified in the middle tier, such as an individual employee's employment contract.

By establishing relationships between major business functions, their tasks/processes and the individual business documents representing actions associated with each task, all elements in the hierarchy can be linked directly or indirectly to each other in a parent-child relationship, and a tree-like map showing the entire hierarchical organization can be developed between a root element and its descendants. This also allows the system to provide a structured document repository for business documents representing individual transactions associated with the tasks and processes related to major business functions.

It is worth noting that multiple factors, each of which could be used individually to organize elements into a hierarchy, can also be combined to create a hierarchical organization. Such a hierarchical organization takes into account multiple factors of information. For example, the employee contracts used previously could be organized first by date of hire and then by their expected duration. Those skilled in the art will understand that other combinations of factors are possible and would fall within the scope of the invention.

A category may refer to a general type or class of business documents, such as those documents related to the Human Resources (HR) department or contracts. Related categories may be organized into their own hierarchy, with a root (top-tier) category being comprised of one or more component sub-categories, which themselves may be comprised of descendant elements. For example, the HR category (a major business function) may be comprised of the Employee contracts sub-category (a related task/process), the Annual Review sub-category (another related task/process) and the Open Positions sub-category (yet another related task/process). These categories and sub-categories constitute a non-exhaustive list as other possibilities remain and fall within the scope of the present invention.

While a category refers to a general type of business documents, a section may refer to one of the constituent elements of a business document stored in the document repository in the third tier. For example, a business document for a given employment contract may be divided into a set of sections that cover related topics such as:
Identification of parties involved in the contract;
Recitals required for the contract;
Interpretation of terms and conditions in the contract;
Purpose of the contract;
Consideration(s) for the contract;
Terms of Payment for the employee;
Security that the contract provides the employee and the organization;
Representations and Warranties made by the employee and the organization;
Obligations and Duties required of both the employee and the organization;
General and Specific Provisions for the contract;
Termination of contract;
Effective Date of the contract;
Duration of the contract (if necessary);
Scope of the contract;
Signatures to the contract; and/or
Schedules, such as for non-disclosure agreements.

Like categories, related sections may also be organized as their own hierarchy with a top-level section being comprised of subsections. Continuing the previous example of the employment contract, a section on terms of payment may be divided into subsections on payment through salary, sales commission, profit-sharing and/or bonuses, among others. These sections and subsections constitute a non-exhaustive list as other possibilities remain and fall within the scope of the present invention.

While business documents of the same type (such as a company's employment contracts) typically contain identical sets of sections and sub-sections, it is also possible that they may differ to a certain degree between each other. For example, an employment contract for an executive may include sections and sub-sections outlining additional conditions of employment, such as clauses that cover termination of employment due to mergers and acquisitions.

An organization may refer to an entity that implements and maintains the system for hierarchical organization of business documents. Such organizations may include private businesses and governmental agencies, as well as public organizations such as charities and non-governmental organizations. The system may be used throughout the organization or in one part of the organization, such as in a division or department. Since the typical organization that uses the system includes businesses, the term organization, business and company are synonymous, except where noted otherwise.

A user may refer to an entity that performs actions within the system in order to achieve a given result, such as managing or updating content that is available through the system. Typical users may include:
In-house or outside legal counsel, such as lawyers, paralegals and support staff drafting contracts;
Organization management, such as corporate managers reviewing details for existing and upcoming contracts;
Company employees, such as employees looking for information about corporate policies and procedures; and/or
Customers, which may include resellers, licensees and external sales representatives, as well as end-users of the company's products.

The users presented here constitute a non-exhaustive list as other possibilities remain and fall within the scope of the present invention.

In order to access the system, a user is required to have a user account. A user account may refer to the information registered with the system that defines a user's identity, their permissions relating to the functionality of the system, as well as permissions relating to content that may be accessible to them via the system. Typically, a user account includes information such as a person's (or entity's) name, their logon credentials (username and password), department, location, telephone number, email address, user level (e.g. administrator, power user or regular user), group membership and permissions, among others. Other information elements for a user account are possible and fall within the scope of the invention. While user accounts will be discussed in more detail, it is worth noting that a group of users may share a user account for the sake of convenience or security. For example, a group of system administrators may share a single user account since this account may be used infrequently to perform maintenance functions.

Those skilled in the art should appreciate that in some embodiments of the invention, all or part of the functionality previously described herein with respect to the system of hierarchical organization of business documents may be implemented as software consisting of a series of instructions for execution by a computing unit. The series of instructions could be stored on a medium which is fixed, tangible and readable directly by the computing unit, (e.g., removable diskette, CD-ROM, ROM, PROM, EPROM or fixed disk), or the instructions could be stored remotely but transmittable to the computing unit via a modem or other interface device (e.g., a communications adapter) connected to a network over a transmission medium. The transmission medium may be either a tangible medium (e.g., optical or analog communications lines) or a medium implemented using wireless techniques (e.g., microwave, infrared, RF or other transmission schemes).

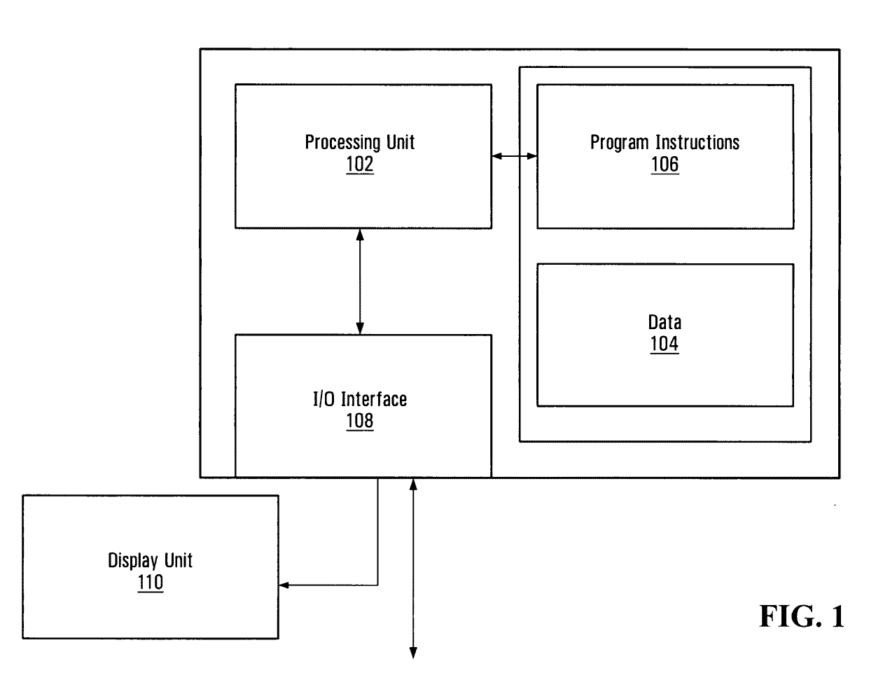

The apparatus for implementing a user interface for displaying a system of hierarchical organization of business documents may be configured as a computing unit 100 of the type depicted in FIG. 1, including a processing unit 102, data 104 and program instructions 106. The processing unit 102 is adapted to process the data 104 and the program instructions 106 in order to implement the functional blocks described in the specification and depicted in the drawings. The computing unit 100 may also include an I/O interface 108 for receiving or sending data elements to external devices. For example, the I/O interface 108 is used for receiving a control signals and/or information from the user, as well as for releasing a signal causing a display unit 110 to display the user interface generated by the program instructions 106. Optionally, the computing unit 100 may include additional interfaces (not shown) for receiving information from additional devices such as a keyboard or pointing device attached to the unit for example. The computing unit shown in FIG. 1 may be part of any suitable computing device including, but not limited to, a desktop/laptop computing device or a portable digital assistant device (PDA), or smartphone (such as a Blackberry™).

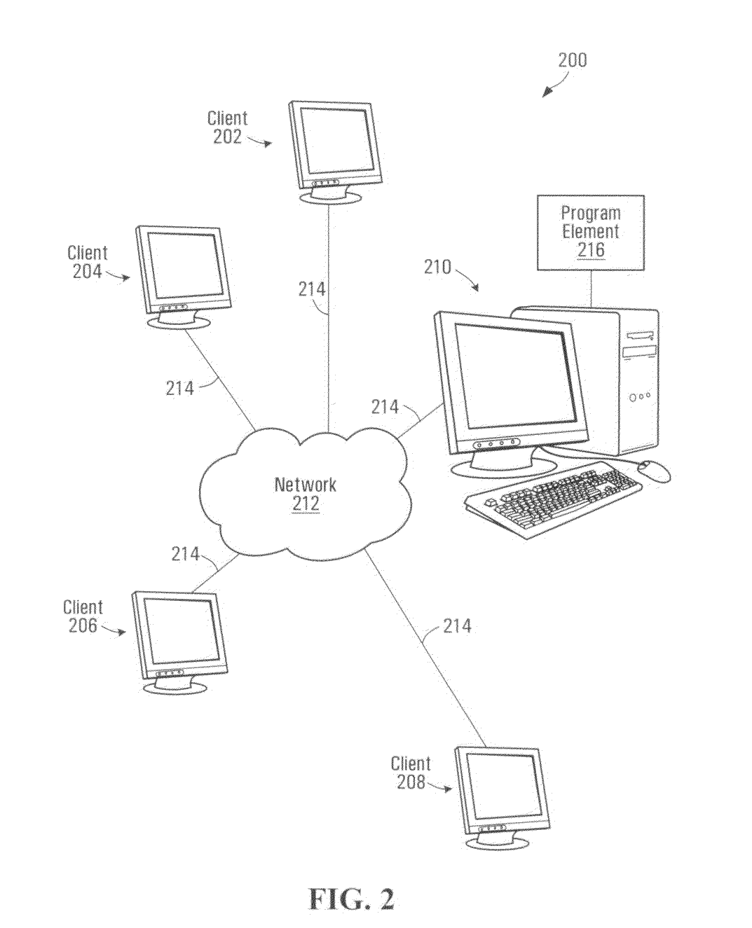

It will be appreciated that the system of hierarchical organization of business documents may also be of a distributed nature whereby a business document is prepared at one location by a suitable computing unit and transmitted over a network to a server unit implementing the graphical user interface (GUI). FIG. 2 illustrates a network-based client-server system 200 for displaying a user interface for the system of hierarchical organization of business documents. The client-server system 200 includes a plurality of client systems 202, 204, 206 and 208 connected to a server system 210 through a network 212. The server system 210 may be adapted to process and issue signals to display multiple business documents originating from multiple client systems concurrently using suitable methods known in the computer-related arts. The communication links 214 between the client systems 202, 204, 206, 208 and the server system 210 can be metallic conductors, optical fibre or wireless, without departing from the spirit of the invention.

The network 212 may be any suitable network including a private wired and/or wireless network, a global public network such as the Internet, or combination thereof. In a preferred embodiment of the invention, the server system 210 and the client systems 202, 204, 206, and 208 are located in the same geographic location and the network 212 is private to the organization implementing the system. In an alternative embodiment of the invention, the server system 210 and the client systems 202, 204, 206 and 208 are distributed geographically and may be connected through the private network with a connection to a global public network, such as the Internet. In another embodiment of the invention, the server system 210 is geographically separate from the organization implementing the system as it is run by a third-party company on behalf of the organization. In this embodiment, the server system 210 and the client systems 202, 204, 206 and 208 are distributed geographically and connections between systems may be made using a global public network, such as the Internet.

The server system 210 includes a program element 216 for execution by a CPU. The program element 216 implements similar functionality as program instructions 106 (shown in FIG. 1) and includes the necessary networking functionality to allow the server system 210 to communicate with the client systems 202, 204, 206, and 208 over the network 212. In a non-limiting implementation, program element 216 includes a number of program element components, each program element component implementing a respective portion of the functionality of the system of hierarchical organization of business documents, including their associated GUIs.

Those skilled in the art should further appreciate that the program instructions 106 and the program element 216 may be written in a number of programming languages for use with many computer architectures or operating systems. For example, some embodiments may be implemented in a procedural programming language (e.g., “C”) or an object oriented programming language (e.g., “C++” or “JAVA”).

A user interacts with the system of hierarchical organization of business documents via the client systems 202, 204, 206, and 208, or more particularly, via the user interface provided by those systems. The user interface allows a user to fully utilize the functionality of the system, including accessing, identifying, adding, modifying and removing business documents accessible through the system. In a specific and non-limiting embodiment of the implementation, the user interface is a GUI. The program instructions 106/the program element 216 may include instructions to generate the GUI for the system on the server system 210 and/or the client systems 202, 204, 206, and 208. Regardless of where the GUI is generated, it typically includes means to deliver visual information to the user via the display unit 110, as well as graphical tools allowing the user to make selections and input commands based on that visual information.

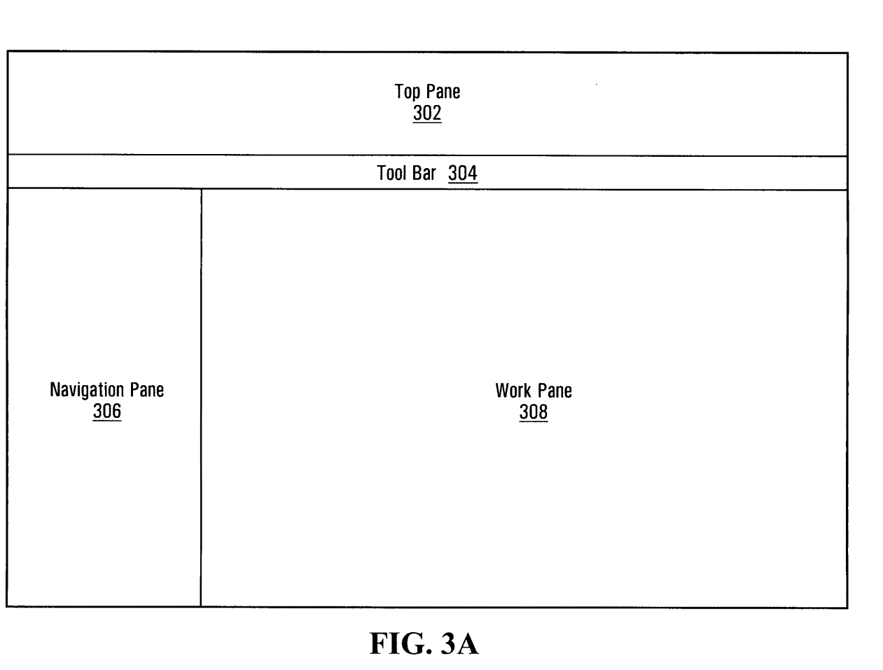

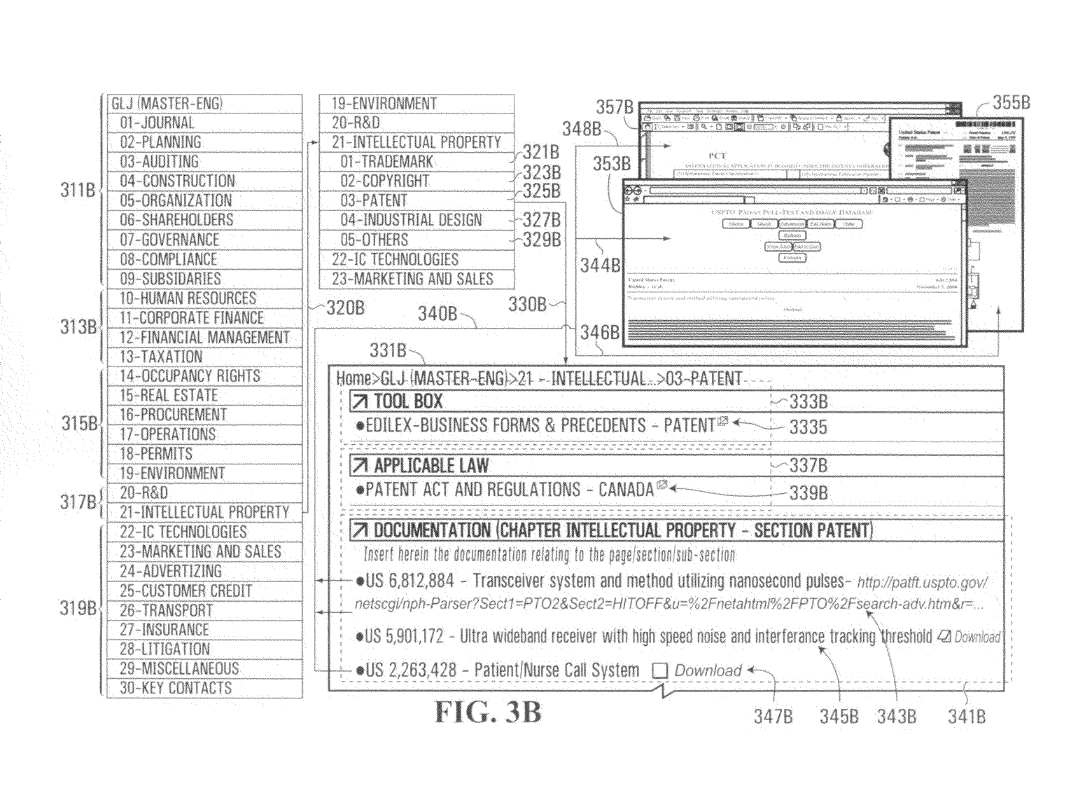

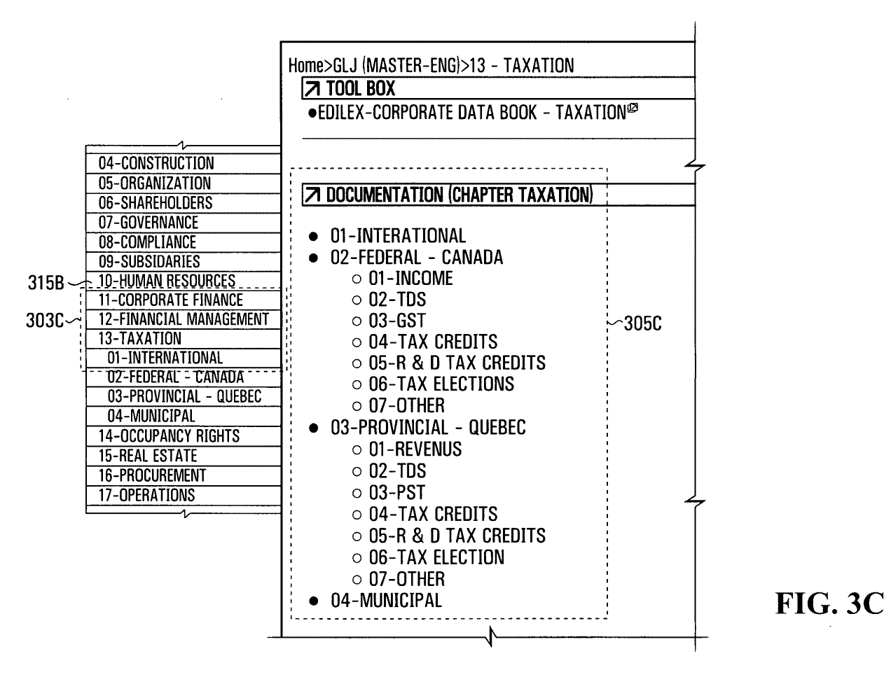

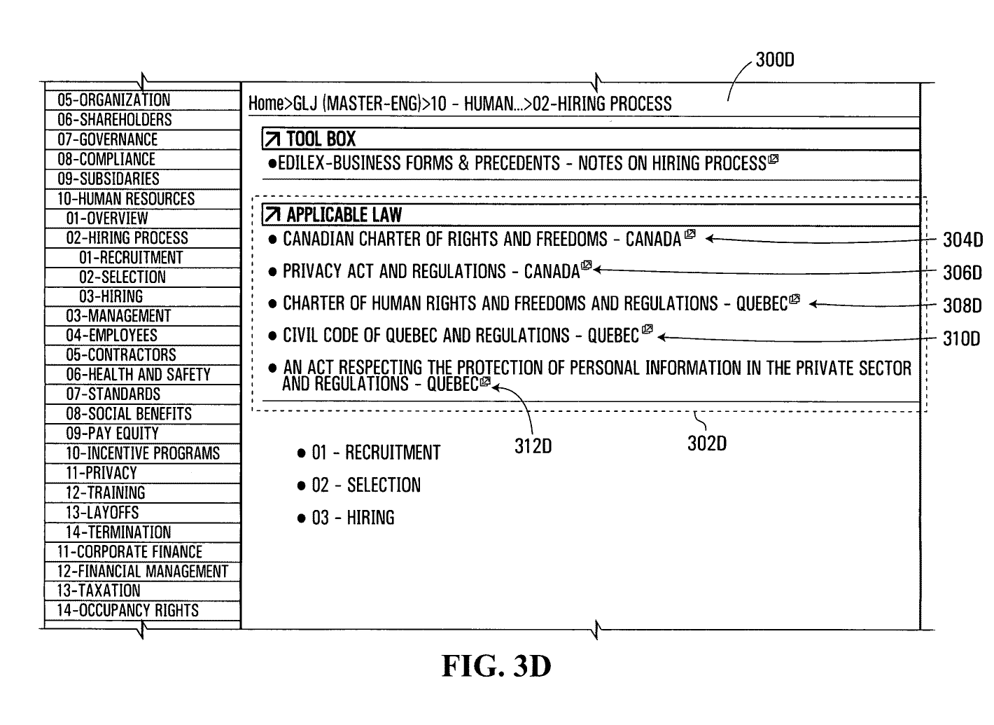

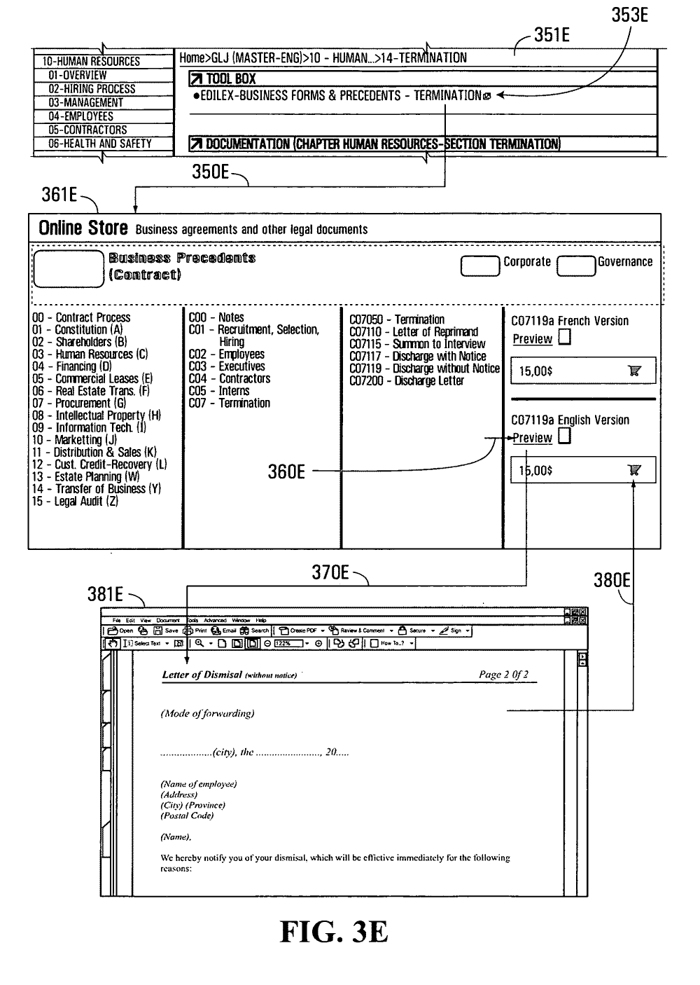

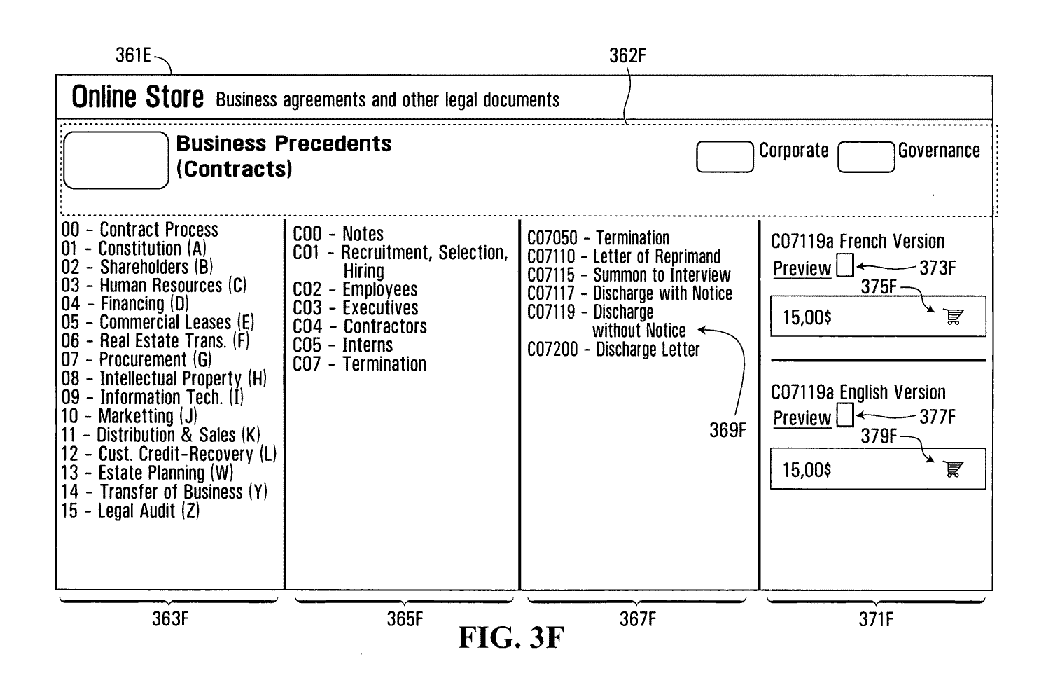

FIG. 3A presents a specific and non-limiting example of implementation of the GUI generated by the system and presented to a user of the system of hierarchical organization of business documents. With respect to this figure, the GUI for the system includes a top pane 302, a tool bar 304, a navigation area 306 and a work pane 308. The top pane 302 includes an identification area for the organization implementing the system and may also include a visual indicator to identify the current status of the overall system to the user. For example, a green visual indicator in the top pane 302 may indicate that the system is working properly, while a yellow or red indicator may indicate that the system is experiencing performance slowdowns due to an unusually heavy load. By this means, users can be notified of issues that may affect the performance of the system.

The tool bar 304 provides access to tools that allow a user to utilize the functionality of the system of hierarchical organization of business documents through a set of clickable controls (such as buttons, hyperlinks or menu items). The tool bar 304 also includes a tool to end their session by logging out of the system.

The navigation pane 306 provides a user with clickable controls that are arranged in a selection component to visually represent the hierarchy of first-, second- and third-tier entries, including individual business documents and their sections and sub-sections. When the user clicks an entry (such as a category in the second tier of the hierarchy), the constituent components of that entry (such as its associated sub-categories) appear in the navigation pane 306. In this way, the clickable controls in the navigation pane 306 allow a user to navigate (or ‘drill-down’) through the represented hierarchy to find the business document in which they are interested.

As a user navigates through the hierarchy of business documents, the work pane 308 is updated to display information and tools relating to the selection within the selection component made by the user in the navigation pane 306. Depending on the selection in the navigation pane 306, the work pane 308 may display a visualization component that may take the form of clickable controls (such as hyperlinks) for constituent elements of the selected element in the hierarchy, as well as external resources related to the element. It is worth noting that although each case is described separately below, hyperlinks for both constituent elements and for external resources may appear as visualization components in the work pane 308.

While the hierarchical organization between categories, sub-categories and business documents (as well as its sections and sub-sections) are represented visually in the navigation pane 306 and the work pane 308, the system also provides a process of identifying such relationships via an alphanumeric co-ordinate system. Such a co-ordinate system (which may include a sequence of numbers, characters and symbols) can help a user quickly identify the level of the hierarchy at which they are located. For example, a co-ordinate system using a so-called system of ‘dot notation’ (whereby each level of the hierarchy is identified with a digit followed by a period) would allow a user who is looking at a business document identified as 3.4.7 to realize that they are looking at a third-tier entry.

The use of such a co-ordinate system in the navigation pane 306 and work pane 308 also allows users to ensure that business documents stored in the system are unique, as well as providing users a shorthand method to quickly refer to such business documents. In a non-limiting example, assume that a portion of the hierarchical organization of Research and Development-related business documents uses the following numerical co-ordinate system:

### 21—R&D

01—Collaborations
02—Research
   01—Fundamental
   02—Applied

With such a hierarchy and co-ordinate system (and by using the dot notation mentioned previously), the sub-category for the third-tier Applied Research entry can be identified as 21.2.2, with business documents within this sub-category identified as 21.2.2.X, where X can refer to another alphanumeric identifier that is incremented in a consistent fashion. The use of this co-ordinate system allows a user to spot duplicate or erroneous entries within the hierarchy, since they would have the same number.

The use of such a co-ordinate system also allows users to refer to entries in the hierarchy simply by their identifier, rather than having to explain each of the steps needed to navigate to the entry. For example, a user within the organization can simply tell another user to look at 21.2.2 in the hierarchy to view the business documents related to the company's applied research, which is simpler and faster than having to explain that they first have to navigate to the R&D category, then to the Research sub-category and finally to the Applied sub-category.

The hierarchical organization of business documents represented by the system through the navigation pane 306 (and/or work pane 308) also provides certain benefits over other known methods of organization, such as maintaining deeply nested structures of folders containing computer-readable files. These advantages include the following:
Single Point of Contact for Business documents: Business documents (and/or their component sections and sub-sections) may be scattered among multiple directories stored on multiple computer systems within an organization. The system provides a single point of contact to access all of these documents, thus reducing the time needed by employees to locate these documents.
Standardization of Business document Structure: Certain types of business documents follow a standard structure or pattern defined through internal policies and/or by external rules and regulations. The system helps maintain this standardization by providing a method to match a business document to its expected (or legally required) structure. The system also provides a means to easily identify documents that depart from their expected structure.
Access to Related Resources: Employees may benefit from access to external resources, such as websites and PDF documents related to the business document. For example, a section on a company's health benefits may include a link to PDF files for the insurance forms needed to claim these benefits.

With respect to FIG. 3B, a non-limiting example will now be presented to show the operation of the system with respect to the hierarchical organization of business documents. Assume that the organization implementing the system has many different contracts and non-contract business documents that can be organized into several root categories, such as:
Procurement-related documents, such as for contracts and agreements with suppliers of products and services used in production;
HR-related contracts, such as for employment contracts and collective agreements;
Intellectual Property-related contracts, such as for patents and technology licensing agreements;
Sales- and Support-related contracts for resellers and/or end-users; and
Materials-related contracts, such as for suppliers of materials and services.

The contracts and contract types listed above are for illustrative purposes and constitute entries in a non-exhaustive list as other possibilities exist and fall within the scope of the invention.

FIG. 3B is a non-limiting representation of the operation of the system of hierarchical organization of business documents when used to identify and retrieve a business document, specifically a patent held by an organization (and more specifically, a patent held by a private company). This figure includes a set of selection components 311B in the navigation pane 306 that is organized within a pre-defined hierarchy. The set of selection components 311B include the root categories (i.e. first-tier elements) identified previously for major business function in the organization, specifically a Human Resources root category 313B, a Taxation category 315B, an R&D (Research and Development) root category 3178 and an Intellectual Property root category 319B.

Further assume that contracts within each root category can be further organized within sub-categories (i.e. second tier elements) that identify subsets of contracts dealing with similar tasks or processes related to the business function. For example, assume that business documents within the Intellectual Property (IP) root category 319B can be organized into task/process-related categories based on the following common types of IP protections:
A Trademarks category 321B;
A Copyrights category 323B;
A Patents category 325B;
An Industrial Designs category 327B; and
An Other category 329B for business documents that do not fit into the above four categories and/or documents (such as inventor's notes or correspondence) that need to be kept separate from their IP protection.

Further assume that the use of a root category and/or descendant category results in an interface containing visual indicators appearing in the work pane 308. FIG. 3B also shows a non-limiting example of a Patent interface 331B generated by the GUI of the system in response to the use of a selection component in the navigation pane 306 that would be a representative example of such an interface. The Patent interface 331B may contain a plurality of sections, such as a Tool Box section 333B, a Related Resources section 337B, and a Documentation section 341B. Each section also contains its own visualization components (such as hyperlinks, fields, buttons or other clickable controls) that will be explained below.

With respect to FIG. 3B, a representative operation of the system of hierarchical organization of business documents will now be explained. In this non-limiting example, assume that an inventor is looking to review their company's patents in order to ensure that technology used in their related invention falls within the scope of patents already held by their employer.

In the first step of the operation (identified as 310B), the inventor scans the set of selection components 311B displayed in the navigation pane 306 to identify the root category that is likeliest to contain business documents, specifically patents. The headings for root categories displayed in the navigation pane 306 allow the inventor to quickly get a sense of what types of business documents may be stored within the descendant categories under each root category. After reviewing the list, the inventor would click the selection component for the Intellectual Property category 319B, which is the most likely root category to contain patents and other IP-related business documents.

Arrow 320B shows how the Intellectual Property root category 319B is expanded in response to the inventor's action to show its descendants, namely the Trademarks category 321B, the Copyrights category 323B, the Patents category 325B, the Industrial Designs category 327B and the Other category 329B. Although FIG. 3B shows this expanded list of descendant categories in the navigation pane 306, it is conceivable that the work pane 308 would also display a similar navigational tool and that all subsequent navigation could be performed through the work pane 308.

The inventor now repeats the action he or she carried out previously in scanning the category headings to determine the most likely category to hold the business documents they are looking for. After reviewing the list, the inventor clicks the selection component for the Patents 325B category, which is the most obvious choice for the type of business document she or he is looking for.

In response, the Patent interface 331B appears in the work pane 308 in response to the inventor's previous actions, as shown by arrow 330B. The interface 331B may contain a plurality of different sections, such as the Tool Box section 333B. Sections on the interface serve to organize related visualization components (such as clickable controls) into groups within a defined physical area, as well as distinguish these groups from each other through the use of titles and/or physically distinguishing characteristics, such as color, shape, or font type/size, among others. Those skilled in the art will understand that other distinguishing characteristics could also be used to identify sections within an interface on the work pane 308.

Each section in the Patent interface 331B acts as a repository for various types of indicia of business documents, such as clickable controls (e.g. hyperlinks) or icons representing computer-readable files such as documents in Adobe PDF format or images in JPEG format. In particular, the Toolbox section 333B contains a link(s) to a business document template 333B for a patent that is sold through an online store where templates of business documents (such as contracts and licensing agreements) can be previewed and purchased. The Applicable Law section 335B also contains a link 337B to the Canadian Patent Act and Regulations, which is the legal framework of laws and statues in Canada regarding patents. The Toolbox section 331B and the Applicable Law section 335B often appear with business documents in the work pane 308 and to provide extra resources to users.

The Documentation section 341B contains business documents, either as inline text or as indicia (such as clickable controls, and more specifically hyperlinks) to the section, subsection or computer-readable file containing the text of the document or a subsection thereof. In this non-limiting example, assume that the text of business documents (in this case, patents) are not maintained within the system itself and visualization components (e.g. clickable controls, such as hyperlinks) presented are links to the patent documents. As a result, the Documentation section 341B contains clickable controls (i.e. hyperlinks) to the following patent documents:
A hyperlink 343B to U.S. Pat. No. 6,812,884, the text of which is stored on the (external) website of the United States Patent Office (USPTO);
A hyperlink 345B to U.S. Pat. No. 5,901,172, the text of which is stored as a computer-readable TIFF image file that is accessible through the system.
A hyperlink 34713 to Canadian Patent 2,263,428, the text of which is stored as a PDF file that is accessible through the system.

In this way, the inventor can see that the company holds three patents (two US patents and one Canadian patent). However, the inventor notices that the first patent (U.S. Pat. No. 6,812,884) seems to involve technology related to a transceiver system using nanosecond pulses, the second patent (U.S. Pat. No. 5,901,172) covers an ultra-wide band receiver, while the last patent (CA 2,263,428) seems to involve a nurse/patent call system that is likely used within a hospital.

Because the objective of the inventor is to ensure that technology used in their invention is covered by patents already held by their employer, the inventor decides to review the text of the three patents themselves to get a better understanding of their details (and perhaps understand how they relate to each other). As shown by arrow 340B, the inventor uses the three clickable controls within the Documentation section 341B to view the full text of their associated patent documents. Because there are three documents to be reviewed, however, the overall action taken by the inventor here is comprised of three separate sub-actions (identified by arrows 344B, 346B and 348B) that are described individually below.

Arrow 344B shows the result of the inventor's use of the hyperlink 343B to access the U.S. Pat. No. 6,812,884 through the system. Because the hyperlink 343B resolves to a webpage on an external website (i.e. the USPTO website), an Internet browser 353B must be used to resolve the website address and display the webpage containing the text of the patent to the inventor, who may read it immediately or print it for later review. While the Internet Browser 353B pictured in FIG. 3B is Microsoft Internet Explorer, those skilled in the art will appreciate that any Internet browser could be used to display the text of the patent.

Arrow 346B shows the result of the inventor's use of the hyperlink 345B to access the U.S. Pat. No. 5,901,172 through the system. Unlike 344B, the hyperlink 345B resolves to a computer-readable TIFF image file 355B that is stored internally on the system, and so an appropriate software application (not shown) must be used to read the image file and display the text of the patent to the inventor, who may read it immediately or print it for later review. Since there are a plurality of software applications and utilities that are capable of displaying the contents of a image files (including those in TIFF format) similar to the TIFF image file 355B, those skilled in the art will understand that any of these applications can be used to display the text of the patent. Like the Internet browser 353B previously, many of these applications and utilities would also allow the inventor to review, save and/or print the text of the patent.

Arrow 348B shows the result of the inventor's use of the hyperlink 347B to access the Canadian patent 2,263,428 through the system. As before, the hyperlink 347B resolves to a computer-readable file that is stored internally on the system, although the format of the file associated with the hyperlink 347B is Adobe PDF (Portable Document Format). As a result, a PDF file reader 357B must be used to read the file and display the text of the patent to the inventor, who may read it immediately or print it for later review. While the PDF reader 357B shown in FIG. 3B is the Adobe Acrobat™ application developed by Adobe, those skilled in the art will appreciate that there are a plurality of suitable applications that are capable of reading PDF files and displaying their contents, and that any one of these applications could be used to display a PDF file that is stored on the system.

Since the inventor has found the business documents representing the three patents held by the company through the system, the operation represented in FIG. 3B ends. While this non-limiting example focused on IP-related business documents (such as patents), other users would perform the same operation to locate and review any business document within the system, including those in other root categories, such as the Human Resources category 313B, the Taxation category 315B and the R&D category 317B.

Navigating to view the contents of a category in the navigation pane 306 may display a plurality of sections in the Work pane 308 that provide extra resources, such as the Toolbox section 331B and the Related Resources section 335B that were identified previously. Other types of extra resources that could be provided to users include:
Calendars, which could be used to show upcoming events;
Forms to collect information from users;
Polls and surveys to allow users to submit their opinions on different events;
News articles, such as related news articles about the general industry;
Press releases, such as those published by the organization to announce new products or services;
Newsletters, which allow an organization to communicate information to its employees and/or outside parties (such as resellers or customers);
Job postings to provide information about available positions within the organization; and/or
Images and/or Image maps that could be provided to users as navigation aids.

The types of extra resources listed above constitute entries in a non-exhaustive list, as other possibilities exist and would fall within the scope of the invention.

Details of four of the most common types of extra resources will be presented:
Navigation aids presented within the work pane 308;
An Applicable Law section, such as the section 337B described earlier;
A Related Resources section;
A Toolbox section, such as the section 333B described earlier; and
Discussions that provide a forum to registered users to discuss related topics and which will be discussed later.

When a user triggers a selection component in the navigation pane 306, a representation of the hierarchy of its dependent categories may also appear as clickable controls within a section of the work pane 308. FIG. 3C shows a non-limiting example of an interface generated by the GUI of the system to represent a hierarchy of dependent categories for the Taxation root category. This figure contains the Taxation root category 315B, a set of Taxation-related selectable components 303C in the navigation pane 306, as well as a set of clickable controls 305C (such as textual hyperlinks) representing the dependant categories below the Taxation root category.

It should be noted that the set of Taxation-related selectable components 303C and the set of clickable controls 305C represent the same hierarchy of dependant categories but the depth of each hierarchy differs. Specifically, the set of selectable components 303C in the navigation pane 306 represents the set of dependant categories that exist immediately below the Taxation root category 315B. In contrast, the set of clickable controls 305C represents the entire hierarchy for the category, including all dependant categories at their proper depth. Because the set of clickable controls 305C shows the entire hierarchy (and also remains independent of the state of the hierarchy displayed in the navigation pane 306), a user can quickly scan this list of dependent categories in order to identify and navigate to the category in which they are interested. It should also be appreciated that other types of clickable controls (such as icons, image- and/or graphic-based hyperlinks) could be used to represent the dependant categories within hierarchy in the set of clickable controls 305C.

When a user triggers a selection component in the navigation pane 306, an Applicable Law section may appear in the work pane 308 that is similar to the section 337B. The purpose of this section is to provide legal framework indicia (such as hyperlinks) used to access the legal framework (i.e. laws, statutes and associated regulations) related to the specified category. FIG. 3D shows a non-limiting example of a Hiring Process interface 300D generated by the GUI of the system that may contain business documents related to the hiring process of the organization. The Hiring Process interface 300D contains an Applicable Law section 302D that provides a set of legal framework indicia (i.e. clickable controls, such as hyperlinks) to online versions of components in the legal framework concerning hiring practices. In particular, the section 302D provides indicia to legal text associated with labour laws, statutes, and associated regulations, including:
A link 304D to the Canadian Charter of Rights and Freedoms;
A link 306D to the Privacy Act;
A link 308D to the Charter of Human Rights and Freedoms and Regulations;
A link 310D to the Civil Code of the province of Quebec; and
A link 312D to the Act Respecting the Protection of Personal Information in the Private Sector and Regulations for the province of Quebec.

It should be understood that a user could add links to other components of the legal framework to the section 302D. For example, links to federal or state laws and regulations in the United States related to hiring practises and/or labor law could be added to this section to provide guidance to U.S. users in addition to Canadian Users.

By consolidating links to all of these components of the legal framework that might concern hiring practises within the Applicable Law section 302D, a user can consult various laws and regulations related to this category from a single place. This both saves time and provides a user with a convenient alternative from having to search for these individual components of the legal framework separately.

When a user triggers a selection component in the navigation pane 306, a Toolbox section similar to the section 333B may appear in the work pane 308. The purpose of this section is to provide template document indicia (such as hyperlinks) that can be used to access third-party resources, and in particular templates for related business documents that can be previewed and purchased through an online store. FIG. 3E shows a non-limiting example of an Employment Termination interface 351E generated by the GUI of the system that may contain business documents related to the employment termination practices of the organization, such as firings and/or dismissals. The Employment Termination interface 351E contains a Toolbox section 353E with a template document indicial (i.e. hyperlink) for a Business Forms control 355E that is a link to an online store that sells templates for business-related forms, such as contract and agreements among others. This figure also contains an interface for an online store 361E and a preview of a business document template 381E, both of which will be discussed below.

FIG. 3F presents a non-limiting example of the online store interface 361E that is displayed through the use of a clickable control in a Toolbox section, such as the Business Forms control 355E. The interface for the online store may be displayed within the same interface as the system (such as in its own tab in an Internet browser) or may be displayed in an entirely separate window. Regardless of method used to display the online store interface 361E, it should be appreciated that the layout of this interface may differ from the layout of general interface of the system that was presented in FIG. 3A. It should also be understood that the language used in the interface for the online store may differ from that of the general system itself. For example, the Employment Termination interface 351E in FIG. 3E is presented in English but could just as easily be presented in another language, such as French. Those skilled in the art will appreciate that other languages for the interface are possible besides the English and French interfaces mentioned here.

With respect to FIG. 3F, the online store interface 361E contains a business category menu 362F, a root category menu 363F, a dependant category menu 365F, a business document template menu 367F and a shopping menu 371F. The business category menu 362F contains clickable controls (e.g. icons) for general groups of legal and non-legal documents pertaining to different aspects of the organization and/or its operations. For example, the business category menu 362F may contain links to groups of legal and non-legal documents for contracts (such as hiring contracts and licensing agreements), corporate structure (such as articles of incorporation) or corporate governance.

Using any of the clickable controls in the business category menu 362F causes the root category menu 363F to display a set of clickable controls representing root categories of business documents that are related to the general business category. For example, selecting “Contracts and Commercial Forms” from the business category menu, causes the root category menu 363F to display root categories of business documents such as “Human Resources”, “Financing” and “Intellectual Property”. While the root categories presented in the root category menu 363F generally correspond to those appearing in the navigation pane 306 of the system, it is also conceivable that the set of root categories may differ in some cases.

Similarly, using any of the clickable controls in the root category menu 363F causes the dependant category menu 365F to display a set of clickable controls that represent dependant categories of business documents related to the selected root category. For example, selecting “Human Resources” in the root category menu 363F causes the dependant category menu 365F to display sub-categories of business documents that are related to human resources, such as “Recruitment, selection and hiring”, “Contractors” and “Termination”. While the dependant categories presented in the dependant category menu 365F generally correspond to those appearing below the root category in the navigation pane of the system 306, it is conceivable that the set of dependant categories may differ. For example, a level 3 or a level 4 sub-category within the hierarchy may be represented in the dependant category menu 365F with sub-categories that exist immediately below the root category.

Likewise, using any of the clickable controls in the dependant category menu 365F, causes the document template menu 367F to display a set of clickable controls representing individual business document templates related to the dependant category selected in the dependant category menu 365F. The term “business document template” may refer to the fully- or partially-completed version of a legal or non-legal business document, such as an employment contract, application form, licensing agreement, articles of incorporation document, patent application, or termination letter among others. A business document template typically contains the following features:
Completed text, commonly referred to as “boilerplate”; and
Blank areas for specified information that can be filled in, such as the name and address of the organization.

These features allow the template to be quickly modified to meet the needs of the organization. For example, selecting “Termination” causes the document template menu 367F to display templates with completed text and blank areas that can be modified to develop business document related to termination of employment, such as a “Letter of Reprimand”, a “Summon to Interview” and a “Discharge without Notice”. It should also be appreciated that using business document templates allow an organization to adopt a standardized approach to their business documents, ensuring a degree of consistency in both the structure and contents of business documents.

Selecting any of the clickable controls in the document template menu 367F causes the shopping menu 371F to display clickable controls that allow a user to preview and/or purchase the template of the business document that is selected in the document template menu 367F. It should be appreciated that menu 371F may contain versions of the business document template in different languages, such as English and French versions, as well as additional annotated versions of the template that contain additional content (not shown). The menu 371F provides preview controls 373F and 377F that allow a user to preview the French and English versions of the business document template, respectively. When a business document template is previewed, a non-functional version of the template is retrieved so that a user can view the template in part or in its entirety in order to decide whether to purchase it or not. In many cases, a template's Table of Contents or a portion of its text can be previewed to understand the general structure of the document and see what may be purchased. The preview of the business document template may occur in the same interface as the online store interface 361E (such as in a separate window) or occur in an entirely separate interface, such as a within a PDF reader application.

The menu 371F also provides purchase controls 375F and 379F that show the price of the business document template and allow a user to add the respective French and/or English templates to a “shopping cart”, which is a temporary repository for templates to be purchased and allows the user to continue shopping for business document templates using the controls previously discussed. Once the user is ready to purchase their selected templates, they initiate a transaction whereby the business document templates in the shopping cart are purchased through a checkout process (not shown) that may include a transaction summary (not shown) that lists the business document template(s) being purchased, their price(s) and the amounts of any taxes, if applicable.

The checkout process also includes methods for the owner of the online store interface 361E (also referred to as the “merchant”) to receive payment for the purchased templates from the user (also referred to as the “purchaser). Forms of payment may include credit cards, deduction from a bank account (i.e. debit purchase), generation of invoices for future billing or a deduction of a given value from the balance of an existing “account” established by the purchaser with the merchant, among others. The methods of payment described above constitute entries in a non-exhaustive list, as other possibilities remain and would fall within the scope of the invention.

Once payment is completed, a confirmation screen (not shown) appears to indicate to the purchaser that the transaction completed successfully. Upon the successful completion of a transaction, a user is permitted to retrieve their purchased business document templates in computer-readable files, such as Microsoft Word™ files. Methods of retrieval that may be available to the purchaser may include direct download of said files from the online store interface 361E, the emailing of said files to the user from the online store, or delivery of said files on a physical medium, such as a removable diskette, CD-ROM or DVD-ROM, among others. These methods of delivery constitute entries in a non-exhaustive list, as other possibilities remain and would fall within the scope of the invention.

Through the online store interface 361E, a user can identify, preview and purchase templates of business documents for use in the organization, and which consequently can be entered into the system for the hierarchical organization of business documents. Using this knowledge, and with respect to FIG. 3E and FIG. 3F, a non-limiting example will be presented to illustrate the general operation of the Toolbox section (such as the section 353E) and its relation to the online store represented by the interface 361E will now be explained. In this example, assume that Bob Jones is a mid-level manager within the organization who has been repeatedly accused of sexual harassment of his female co-workers. After finding evidence to support these accusations and conferring with their legal counsel, the company has decided to terminate his employment without prior notice. Because of the sensitive nature of this dismissal, however, legal counsel has advised the organization that they should prepare a document beforehand to give to Bob Jones explaining the reasons for his dismissal and act as an official record of the action. While the HR department has been asked to prepare such a document, the HR representative in charge of this task realizes that are no forms covering such a situation as this is the first such dismissal in the company.

The HR representative decides to look for similar documents within the system for the hierarchical organization of business documents. By navigating the hierarchy in the manner described earlier, the HR representative identifies the appropriate control in the toolbox section 353E. Arrow 350E represents the action of a user navigating to the Toolbox section 353E and then using the Business Forms control 355E to view templates of business documents related to employment termination that are available for purchase to see if there is a form that would suit this situation. In response, the system connects the user to the online store, which then appears in the online interface 361E.

By default, Business Forms controls like the control 355E are configured to display business document templates in the online store interface 361E that are related to the interface on which they are located. As a result, triggering the Business Forms control 355E from the Employment Termination interface 351E causes the online store interface 361E to pre-populate the business category menu 362F, the root category menu 363F, a dependant category menu 365F and the business document template menu 367F with business document templates related to employment termination. This saves a user time in finding the template for the business document necessary, although the user is not restricted to only this set of business document templates and may navigate to other business documents within the online store.

Arrow 360E represents the action of the HR representative scanning the list of business document templates available through the online store interface 361E related to employment termination and selects the “C07119 Discharge without Notice”, which sounds like a business document appropriate to this situation. In response, the shopping menu 369F displays the preview controls 373F and 377F as well as the purchase controls 375F and 379F for the French and English versions of this document respectively.

Next, the HR representative uses the preview control 377F to preview the selected business document template and view it in more detail before making a decision about whether to purchase the template, as represented by 370E. In response, the online store interface 361E displays the preview of the business document template 381E for the Letter of dismissal as a PDF file in a suitable PDF reader application, such as Adobe Acrobat. It should be understood that because this business document template is short, the preview of a business document template 381E appears in its entirety. However, the preview of a business document template 381E for templates of longer business documents may only display a subset of the template, such as its table of contents or a portion of the text.

With this preview, the HR representative decides that, based on the preview, the selected business document template is exactly what is needed to handle the dismissal of Bob Jones, which is represented by arrow 380E. As a result, the HR representative clicks the purchase control 379F to add the business document template to their shopping cart, go through the checkout procedure and purchase the template, thus ending the operation with a successful conclusion.

Although this non-limiting example focused on the purchase of business document templates through the link between Business Forms controls (such as the control 353E) in the Toolbox section of the system and an online store, such as the online store interface 361F, it should be appreciated that other types of products and services could be offered in the same way. For example, the Toolbox section for a company document describing policies and procedures regarding the hiring of contract and temporary workers could provide links to personnel agencies used by the organization to provide such workers in addition to links to business documents templates offered through the online store interface 361E. By centralizing all of these resources in a single location, a user can save time, as well as be provided with access to resources they may not have known of otherwise.

It should also be appreciated that the previous non-limiting examples shows how individual business documents in the system can be quickly found by someone (such as an inventor or HR representative) with a minimum of information provided initially. In the case of the inventor, the inventor only needed to know the type of document they were looking for (i.e. patents) beforehand to drill down to the category within the hierarchy where the correct business documents were located. In the example with the HR representative, the HR representative did not know the type of business document they were looking for and only knew that they were looking for some document related to employee dismissals given without prior notice.

While the hierarchy for the examples presented above extended through two or three levels, it is conceivable that the organizational practises of a firm, as well as the complexity of other business documents may require a hierarchy of a greater or lesser depth. Therefore, the system supports hierarchies of differing depth both at the category level as well as at the section level. For example, assume that the Human Resources root category contained sub-categories for hiring agreements, employee contracts and termination agreements, with an additional sub-category below the employee contracts category to organize contracts based on the status of the employee. With these factors in mind, one possible hierarchy for the employment contract for a chief executive officer (CEO) employed with the organization can be constructed with seven (7) levels, as illustrated below:

```
Human Resources (root)
  General Points (Level 2)
  Recruiting and Selection
  Executives
      CEO (Level 3)
        Contract (Level 4)
          Interpretation (Level 5)
            Terminology (Level 6)
              Activities (Level 7)
              Admissible Expenses (Level 7)
              . . .
              Trial Period
              Year (Level 7)
          Employment (Level 6)
          Remuneration
          Terms and Conditions of Payment
          Representations
          Obligations of the Manager
          Obligations of the Corporation
          Special Provisions
          General Provisions
          End of the Agreement
          Effective Date
          Term
          Scope
          Schedules (Level 6)
  Employees (Level 2)
  Self-Employed Worker
  Health and Safety
  Labour Standards
  Social Programs
  Pay Equity
  Profit-Sharing Plans
  Personal Information
  Training
  Layoff and Reassignment (Level 2)
```

Hierarchies with differing depth at the section and subsection level are also supported by the system to accommodate business documents of varying complexity. For example, the employment contract that was mentioned in the previous non-limiting example for an employee may be substantially simpler than that of the organization's CEO. In such a case, the hierarchy for an employee's employment contract would also be simpler than that required for the employment contract of their organization's CEO, as illustrated below:

```
Human Resources (root)
  General Points (Level 2)
  Recruiting and Selection
  Executives
  Employees (Level 2)
      Employee 1 (Level 3)
        Identification of Parties (Level 4)
        Recitals
        Interpretation
        Purpose
        Consideration
        Terms of Payment
        Security
        Representation and Warranties
        Obligations and Duties
        Specific Provisions
        General Provisions
        Termination
        Effective Date
        Duration
        Scope
        Signatures
        Schedules
      . . .
      Employee N (Level 3)
  Self-Employed Worker (Level 2)
  Health and Safety
  Labour Standards
  Social Programs
  Pay Equity
  Profit-Sharing Plans
  Personal Information
  Training
  Layoff and Reassignment (Level 2)
```

The non-limiting example presented above focused on the hierarchical organization of business documents related to intellectual property (e.g. patents) and HR activities, such as hiring employees. Those skilled in the art will understand, however, that this functionality can be applied to many other types of business documents (such as company policies and regulations), as well as to legal documentation other than contracts. In such cases, the hierarchy that was used for the legal contract can be adapted at the category/sub-category and the section/subsection levels to the business document. The following table shows several possible ways the hierarchical organization can be adapted to different types of business documents:

| | | | Company |
|---|---|---|---|
| | Legal Contract | Non-Contract Legal | Regulations |
| | (e.g. Employment | Document | (e.g. Employee |
| | Contracts | (e.g. Tax Forms) | Handbook) |
| Category | Human Resources | Taxation | Administrative |
| | | | Policies and |
| | | | Procedures |
| Sub-Category | Employees | Tax Credits | Employees |
| Business | Employment | Tax Credit forms - | Personnel |
| document | Contract for | 2008 | Policies and |
| | Employee N | | Procedures |
| Section(s) | Salary | R&D Tax Credit | Time Off |
| | | Apprenticeship | |
| | | Job Creation Tax | |
| | | Credit | |
| Subsection(s) | Annual Salary | N/A | Policy |
| | Salary Reviews | | Regarding |
| | | | Paid Vacations |

The previous examples have focused mainly on the hierarchical organization of business documents in the system for users inside of the organization, such as company employees or managers. It is also conceivable that business documents designed for users outside of the organization (such as resellers, end users and/or investors) could also be made available via the system. For example, technical documentation such as User Guides or Installation Guides could be organized into a hierarchical organization within the system and made available to support the company's products or services with resellers and/or customers. Other business documents relating to corporate communications (such as company newsletters, press announcements or white papers), as well as corporate financial statements (e.g. annual and interim financial reports) could be organized hierarchically within the system and made available to interested parties such as investors and/or government agencies.

Through the use of hierarchies and elements within those hierarchies, the system of hierarchical organization of business documents simplifies the process by which a user is able to locate business documents and navigate within them to find content. However, it is conceivable that the information which forms the basis of a business document may change over time as the organization meets new challenges and adapts to new situations. For example, clauses in sales or supplier contracts may need to be adjusted due to overall industry expansion or contraction that has occurred since the time the clauses were originally drafted.

As a result, there is a need to update and manage content contained within business documents that are accessible via the system of hierarchical organization of business documents. To accommodate this, the system provides functionality that allows a user to perform certain content management tasks associated with business documents.

Content management may refer to actions that support the lifecycle of business documents and/or the information stored within business documents. Tasks involved with content management can be generally categorized into tasks that create a business document, tasks related updates of the business document as it changes over time, and tasks that remove the business document once its usefulness to the organization has expired.

Performing these content management tasks through the system provides time savings and convenience to a user for the following reasons:
The user can update business documents and their content through a single interface. The alternative to performing content management tasks through the system would involve finding the original file containing this content, updating this content and then distributing the updated file to all interested parties.
Users can add and contribute information about a business document through the system. User comments are kept are separate from the document and can be integrated into the main business document at a later time.
Should a business document become corrupted or be abused, the contributing content management actions can be reconstructed to see how the document was brought to its current state, and the document be restored to a prior state.
Restrictions on business documents (as well as content-management tasks associated with these documents) can be implemented to restrict access and protect the content contained therein. Content management actions related to restricting access to business documents will be discussed later in relation to user accounts, access and confidentiality.

The system for hierarchical organization of business documents provides functionality for the following content management-related tasks: adding business documents, viewing business documents, editing business documents, scheduling business documents, annotating business documents and deleting business documents from the system. While these tasks are described individually below, it should be understood that a user may perform any or all of these tasks and perform them in no predetermined order.

It is likely that most users will be using the system to locate and review business documents through their hierarchical organization, and not perform content management tasks on these documents. Because of this, the system runs in two modes: a default “viewing mode” that facilitates access to business documents and a separate “editing mode” that allows content management tasks to be performed on business documents. It is worth noting that a user must manually switch in to and out of the editing mode via a clickable control in the work pane 308. Otherwise, the user cannot access the editing mode of the system and is restricted to viewing business documents only.

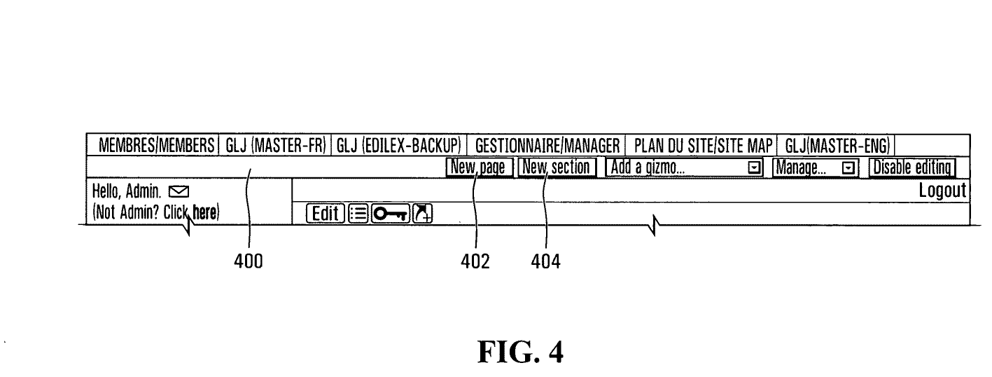

The action of adding a business document to the system may involve creating the hierarchy (or portion thereof) where the business document is located, in addition to creating the business document or link to the resource. FIG. 4 shows a non-limiting example of an interface 400 that contains clickable controls that can be used to add business documents to a hierarchical organization through the GUI of the system displayed in the Work pane 308. With respect to this figure, a New Page clickable control 402 adds a new business document to the hierarchy, while a New Section clickable control 404 on the interface 400 can be used to add a section to the business document, such as for related resources.

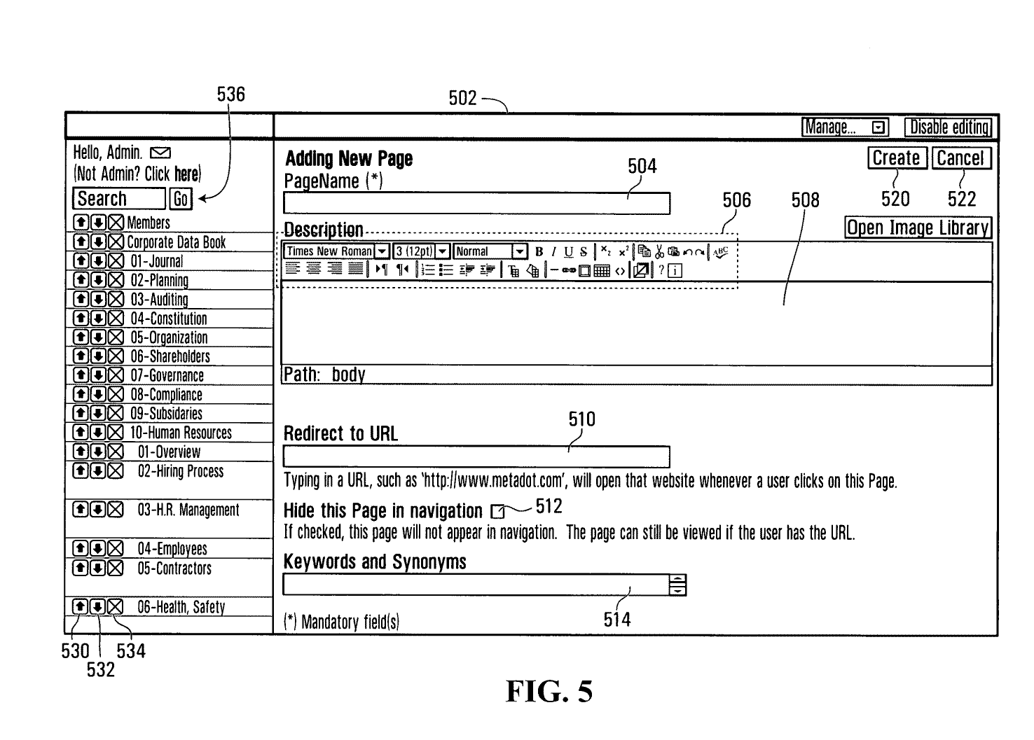

FIG. 5 shows a non-limiting example of a New Page interface 502 generated by the GUI of the system in response to the use of the New Page clickable control 402, which can be used to add a business document for a business document to the hierarchical organization of business documents within the system. The New Page interface 502 in the work pane 308 contains a Name field 504, a set of content entry and formatting controls 506, a text entry field 508, a URL redirection field 510, a Visibility control 512, a Keywords field 514, a Create clickable control 520, a Cancel clickable control 522. When the New Page interface is displayed, the navigation pane 306 may also display a Move Up control 530, a Move Down control 532 and a Page Deletion control 534 for each page associated with an entry listed in the hierarchy, as well as a Search field 536.

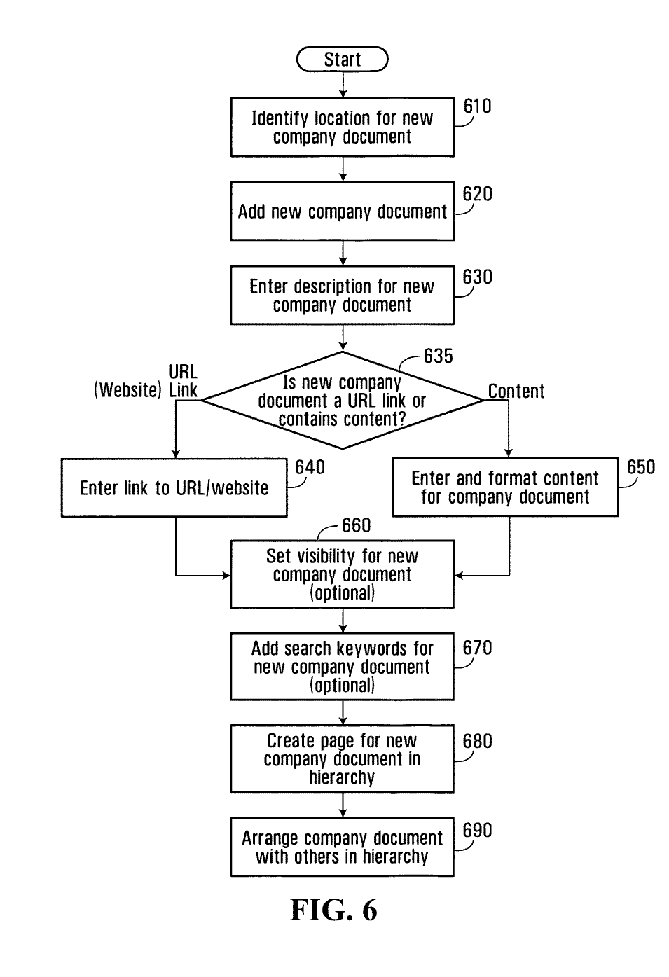

FIG. 6 is a block diagram showing the process by which a new business document is added to the hierarchical organization of business documents. The starting point for this figure is the navigation pane 306. In step 610, the preferred location for the new business document is identified in the overall hierarchy. In this step, a user navigates through the existing hierarchy and locates the category or sub-category under which they want to add the new business document.

In a non-limiting example, assume that a new employee, Mary Ioanna is joining the organization and that her hiring agreement is being added to the system by an HR representative. Further assume that the hierarchy used to organize these business documents corresponds to the following structure:

```
Human Resources (root category)
  Hiring Process (Level 2)
    Recruitment (Level 3)
    Selection (Level 3)
    Hiring (Level 3)
      Employee Hiring Agreements (Level 4)
      Employee 1 (Level 5)
        Salary Offered (Level 6)
        Start Date Offered
      . . .
      Employee N (Level 5)
```

Since each employee's hiring agreement is below the main Employee Hiring Agreements category (level 4), the HR representative must start at this category in order to have Mary's new hiring agreement appear below it. Otherwise, the business document representing her hiring agreement would be added at the wrong place in the hierarchy.

In step 620, the new business document is added by using the New Page clickable control 402 identified previously in FIG. 4. In response, the New Page interface 502 appears in the work pane 308 so that the user can configure the new business document to be created.

In step 630, an alphanumeric name for the new business document is entered in the Name field 504. The alphanumeric name in the Name field 504 will appear in the hierarchy and is automatically indexed by the system so it can be searched by users.

Continuing the previous non-limiting example, assume that the HR representative navigated to the Hiring Agreements level in the hierarchy and has used the New Page clickable control 402 to display the New Page dialog. Further assume that the organization uses the following convention to identify employee contracts (such as hiring agreements: [employee number]—[last name], [first initial]. Because Mary Ioanna is the 24^{th} employee in the organization, the HR representative would enter “24—Ioanna, M” in the Name field to identify the business document representing Mary's hiring agreement.

In step 635, the user must decide whether the entry in the hierarchy created by the new business document will be a link to another destination or will contain content. In certain cases, it makes sense to create a link from the hierarchy category or sub-category directly to another file representing the business document. For example, if all sales contracts are scanned and saved as PDF files, it may be redundant to replicate the entire structure of these contracts in the system. In such a case, a link to the PDF file representing the business document is created directly from the entry for the contract in the hierarchy so that the PDF of the contract appears when a user clicks on the entry for the sales contract.

If the entry in the hierarchy is meant to be a link to another destination, the user performs step 640. In this step, the user enters the URL (website address) for the desired destination in the URL redirection field 510. The URL entered can be an address for a computer-readable file (such as a PDF file), a website (such as a page on the company intranet) and/or multimedia content (such a Microsoft AVI movie file). The URL examples above constitute entries in a non-exhaustive list as other possibilities exist and would be covered by the scope of the invention.

If the entry in the hierarchy is meant to contain content, the user performs step 650. In this step, the user enters and formats the content using the set of content entry and formatting controls 506 and the text entry field 508. It should be understood that content within a business document may include hyperlinks to files, website, and other resources. In this way, the content for the business document can be entered and formatted according to any standards enforced by the organization regarding such matters.

Continuing the earlier non-limiting example of the hiring agreement, if the HR representative wanted to enter the text of the agreement to the system, they could enter it into the text entry field 508 (possibly by copying and pasting it from another document) and then format it using the set of content entry and formatting controls 506. Conversely, if hiring agreements are simply saved as computer-readable files, the representative could also create a link to the file so that the file is opened when the clickable control in the navigation menu 306 is used.

It is conceivable that many of the business documents stored within the system are organized into multiple sections, such as a contract with many clauses or a company handbook containing multiple policies and procedures. There are multiple ways to structure a multi-sectional document within the system, including the following:
Creating a single hierarchy entry for the entire document, and using formatting (such as bold or italic type and/or size) to identify different sections;
Creating a single hierarchy entry for the document and then creating an on-screen “section” (i.e. graphically distinct areas) within the main document to identify each section; and/or
Creating a separate hierarchy entry for each subsection.

Although the system provides an individual user with considerable freedom in determining how he or she structures a multi-section business document, an organization may wish to ensure that all such documents comply with a particular structure or format. In such cases, an organization may require usage of a business document template that is purchased or accessed through the online store mentioned earlier with respect to FIG. 3E and FIG. 3F. The templates available through the online store are designed to ensure that new business documents conform to a common structure. An organization may also employ a benchmarking tool that will be described later to ensure that its existing business documents comply with the common structure enforced through the system.

While FIG. 6 explains the process involved in to structuring a business document within the system using both the first and last methods, there are slight differences in the process for the second method. The differences between the second method and the others are its starting point (i.e. the business document in which a section is to be created, rather than the hierarchy level below which the document should appear) and the clickable control used (i.e. the New Section clickable control 404, rather than the New Page clickable control 402).

In step 660, the user determines whether the business document should be visible in the hierarchy represented in the navigation pane 306. If the business document should be hidden (i.e. not appears) in the navigation pane 306, the user enables the Visibility control 512. A business document with this control enabled is only accessible directly, such as through its URL address. Although the concepts of document confidentiality and user permissions will be discussed later, it should be understood that the Visibility control 512 is not a substitute for proper user access control since any user with the URL address of the business document can access it. This step is also considered optional since a business document could be created without assigning its visibility; by default, a document is made visible unless otherwise specified.

In step 670, keywords relating to the business document may be entered in the Keywords field 514 to increase the likelihood of the document being found through a search. Although the navigation pane 306 provides a fast and convenient way of finding business documents accessible through the system, the system also provides a search engine accessible via the Search field 536 that allows users to enter search terms and find documents containing (or that are related to) those terms. By default, certain terms of a business document (such as its title) are automatically indexed for such searches. However, additional keywords can be added to the business document through the Keywords field 514 to increase the chances of a user finding the document. For example, additional keywords relating to Mary Ioanna's hiring agreement could include terms like: “hiring”, “agreement”, “HR” and the name of Mary's department and/or future manager. This step is considered optional since a business document can be created without entering any search keywords.

In step 680, the Create clickable control 520 is used to add the business document to the hierarchical organization of business documents within the system. If the Visibility control 512 was enabled at step 660, the document is added but does not appear within the hierarchy displayed in the navigation pane 306. Otherwise, a new entry for the business document appears in the navigation pane 306.

New entries in the hierarchy typically appear at the very top or bottom of the category/sub-category in which they are created, which may not be the desired place for the company directory within the hierarchy. In the example with the hiring agreement, assume that after the business document for Mary Ioanna was created, the hierarchy in the navigation pane 306 appears as follows:

```
Human Resources (root category)
  Hiring Process (Level 2)
    Recruitment (Level 3)
    Selection (Level 3)
    Hiring (Level 3)
      Employee Hiring Agreements (Level 4)
        24 - Ioanna, Mary
        01 - Habramov, Vasily
        02 - Wender, Luke
        . . .
        23 - Li, Wen Bo Wan
```

In step 690, the order of business documents is adjusted using the Move Up control 530 and the Move Down control 532 in the navigation pane 306 to reposition the hierarchy entry for the newly added business document within its category in the hierarchy. The terms “Move Up” and “Move Down” generally refer to repositioning the relative location of a business document within a set of such documents contained in a given branch of the hierarchy. These controls cannot be used to promote or demote a business document outside of its given branch, such as promoting a sub-category entry to a full category within the hierarchy.

Continuing the non-limiting example of the hiring agreement, the HR representative would use the Move Up control 530 and the Move Down control 532 to reposition the entry for Mary Ioanna's hiring agreement to conform to the convention used to organize such agreements (i.e. arranging by employee number). After performing step 690, the corrected hierarchy in the navigation pane 306 appears as follows:

```
Human Resources (root category)
  Hiring Process (Level 2)
    Recruitment (Level 3)
    Selection (Level 3)
    Hiring (Level 3)
      Employee Hiring Agreements (Level 4)
        01 - Habramov, Vasily
        02 - Wender, Luke
        . . .
        23 - Li, Wen Bo Wan
        24 - Ioanna, Mary
```

Once a business document has been added to the system, it becomes viewable to other users through the navigation pane 306. The process by which a user can navigate the hierarchy in the navigation pane 306 and view a document in the work pane 308 has been described previously and need not be reiterated here. However, it is worth noting that users can also view business documents accessible through the system by doing the following:
Performing a search by entering keywords into the Search field 536 and selecting the document from the list of results that appears in the work pane 308; or
Entering the location of the business document (such as its URL address), such as when the visibility of the business document has been hidden.

In general, a set of related business documents (such as supplier contracts or patents) residing within the system are expected to share certain common structural elements. For example, the structure of each hiring agreement identified in the previous example is expected to contain two sections: one section listing the starting salary that was offered to the employee and another section listing their expected start date. Having common structural elements helps to ensure that individual business documents for contracts and non-contract legal documents are generally consistent and may also allow faster user navigation in the navigation pane 306 or the work pane 308.

However, there may be cases where the structural elements of an existing business document within the system may vary from what is expected for this type of document. For example, a hiring agreement for an executive may differ from that of a regular employee through additional clauses that specify additional benefits for executives, such as the use of a company car and/or the grant of stock options. While slight variations in the structural elements of a related set of business document may be expected, an organization would want to identify cases where the structural elements of a business document vary significantly from what is expected. Such wide variations may identify issues with the underlying business document that need to be corrected, such as a supplier contract containing contradictory clauses that were entered mistakenly.

To do this, a company assesses the business document within the system using a benchmarking tool. A “benchmarking tool” may refer to a device that identifies the expected structural elements for a business document and records (or allows the recording of) variations from those elements in existing documents. A benchmarking tool acts as a checklist that can ensure that the structural elements within a business document exist and are correctly defined, as well as identify cases where these conditions are violated and may therefore require attention.

In the preferred embodiment of the system, benchmarking tools for a business document can be provided with its business document template through the online store described earlier as a computer-readable file, such as a Microsoft Word document. In such a case, a user of the online store could purchase or access computer-readable files for the template for the business document, as well as its associated benchmarking tool.

In a non-limiting example, a benchmarking tool could be a table with columns for the following:
A detailed list of structural elements that are expected to be in a given business document;
The location(s) of each structural element is recorded in the existing business document; and
Notes recording any variations or discrepancies can be recorded for each structural element.

A portion of such a benchmarking tool for a business document representing an employment contract for a sales representative is provided below:

| | | |
|---|---|---|
| Element | Location | Variation |

```
6.00 Duties and obligations of the
company
    6.01 Automobile
    6.02 Traveling fees
    6.03 Promotional materiel
    6.04 Territory
    6.05 Production
    6.06 Sick days
    6.07 Invalidity insurance
    6.08 Pension fund
    6.09 Vacation
    6.10 Personal information
```

This table allows a user to review an existing business document in the system by comparing its structural elements against those in the benchmarking tool. To use the benchmarking tool, a user first locates within the existing business document, records its location, and then notes any variation or discrepancies for each structural element in a business document, such as a particular definition or clause. In cases where significant variations or discrepancies are found, the benchmarking tool acts as a report that can be circulated and/or escalated to others within the organization.

In a non-limiting example, assume the benchmarking tool is used by an organization to review the employment contracts of all of its salespeople that are available through the system. During the review of the contract for Bob Jones, one such salesperson, the reviewer notices the following:
Bob Jones is provided substantially higher travelling fees than are provided for other salespeople;
The sick days available to Bob Jones are fewer than the company standard for salespeople;
The vacation days in section 6.09 are different than those identified earlier in the contract;
A First Right of Contact section is included in Bob Jones' contract that is not included in the contracts of other salespeople; and
The Personal Information section is missing from Bob Jones' contract.

As a result, the result of the benchmark tool for Bob Jones' contract may appear similar to the following:

| Element | Location | Variation |
|---|---|---|
| 6.00 Duties and | Pg. 19 | |
| obligations of | | |
| the company | | |
| 6.01 Automobile | Pg. 19 | |
| 6.02 Traveling fees | Pg. 19 | Fees are 25% higher than other |
| | | salespeople. |
| 6.03 Promotional | Pg. 20 | |
| materiel | | |
| 6.04 Territory | Pg. 20 | |
| Right of First | Pg. 21 | New section that allows Bob Jones |
| Contact | | right to contact new prospects first; |
| | | not in other contracts. |
| 6.05 Production | Pg. 21 | |
| 6.06 Sick days | Pg. 22 | Only 3 sick days provided; |
| | | standard is 5 days. |
| 6.07 Invalidity | Pg. 22 | |
| insurance | | |
| 6.08 Pension fund | Pg. 23 | |
| 6.09 Vacation | Pg. 23 & | 1 week (i.e. 5 days) listed in clause |
| | Pg. 7 | 1.3 on pg. 7 but 2 weeks |
| | | (i.e. 10 days) promised on pg. 23. |
| 6.10 Personal | N/A | Not in this contract. |
| information | | |

The resulting report that is generated by the use of benchmarking tool for Bob Jones' employment contract can then be escalated to determine whether changes to the contact are required to bring it in to line with the contracts of other salespeople in the organization. The most likely use of the resulting report generated by the benchmarking tool is as a guide to help the organization modify the business document to remove the variations and/or discrepancies so that its structure corresponds to a given pre-defined standard for the organization. For example, it is likely that the Vice President of Sales or Human Resources for the organization may want to review Bob Jones' contract to determine the amount of vacation time he is allowed and/or to add a personal information section to the contract to bring these into line with other employment contracts in the organization.

Although the benchmarking tool is a useful guide for the purpose of enforcing consistency across business documents, it is possible that certain extenuating circumstances may allow certain identified variations or discrepancies to remain in a business document. For example, the higher travelling fees specified in Bob Jones' contract may be justified (and presumably be allowed to remain) if he is a senior salesperson who consistently generates considerable sales volume for the organization.

In addition, variations or discrepancies identified by the benchmarking tool that are repeatedly identified by the benchmarking tool may indicate a change that should be made to the standard business document used by the company. For example, assume that the business document representing an employment contract includes a standard no-compete clause that forbids an employee of the organization from working for the competition for an indeterminate duration after they leave the organization. During salary negotiation, however, each employee has had this clause adjusted so that the period during which he or she is forbidden to work for a competing company is limited to a term of several years. When the HR department in the organization reviews its employment contracts using the benchmarking tool, this discrepancy is noted in every contract. As a result, the HR department decides to modify the no-compete clause in its employment contract so that every employee (both new and existing employees) is forbidden from working for a competitor for a fixed period of five (5) years.

In an alternate embodiment, benchmarking tools could be automated and integrated internally within the system. In this embodiment, these tools would run in the background to check that the structural elements of business documents being added to the system conform to a pre-defined standard for the organization. If the benchmarking tool found exceptions to these standards in business documents residing in the system, the tool could communicate these exceptions to a user (or set of users) through a generated alert or report similar to the benchmarking tool report that was identified previously.

Content management tasks that can be performed in the system of hierarchical organization of business documents include those involving the update or modification of content in a business document to accommodate changes to the underlying information. A “content update” may refer to a wholesale change of the content, such as the replacement of a computer-readable file (such as a PDF document) with a new version. Content updates may occur when the changes to a business document are so great that replacing the older version of the business document with a new one may make more sense than spending the time needed to enter the changes to the document and bring it up to date.

It should be understood that even though a content update replaces an old version of content with a newer version, a copy of the old version of the content may be maintained within the system. This allows a user to restore the previous version of a business document in case of file corruption and/or abuse. For example, assume that a company phone directory maintained as a Microsoft Excel file is made accessible through the system. Each month, the file containing the phone directory is updated in Excel and then added to the system, while last month's Excel file is archived. Further assume that one month, the Excel file for the phone directory is infected by a computer virus. Once this situation is identified, the Excel file in the system is reverted to that of the previous month, which was known to be virus-free. Although the reverted version of the telephone directory is one month out-of-date, it can act as a useful backup until the virus is removed from the current month's telephone directory.

In contrast, the term “content modification” refers to a partial update to existing content. Content modification may occur when changes to a business document are minimal or are of a scale that does not require a content update. Returning to the previous non-limiting example of the hiring agreement, assume that the starting date for Mary Ioanna has been moved back by a week. Rather than recreate the business document in the system to reflect this change, the FIR representative could simply change the start date currently listed in the business document to reflect this change.

The decision about whether to perform a content update or content modification of a business document is left to the discretion of the organization, but it is likely that an organization may perform content updates at regular intervals while performing content modifications at irregular intervals. For example, assume that an airline reviews and renews supplier contracts on an annual basis. Further assume that the price of certain goods included within the contract terms change within a much smaller window of time due to underlying economic changes, such as the varying price of oil and/or airline fuel. As a result, the airline may perform a content update for each supplier contract once a year after its annual review, but perform multiple content modifications throughout the year as suppliers change their costs due to varying underlying factors.

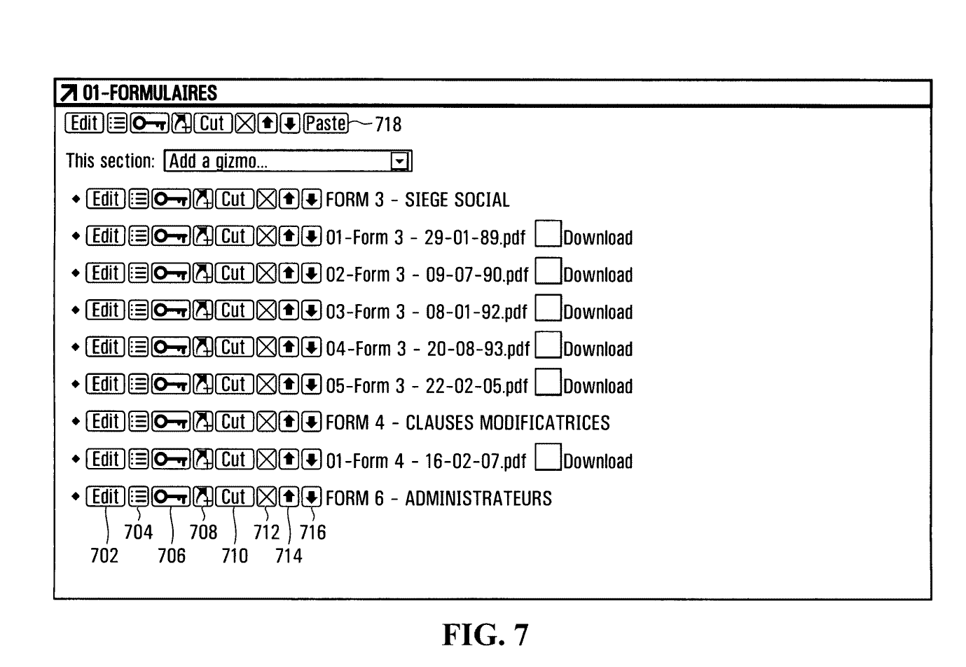

FIG. 7 shows a non-limiting example of a set of editing tools available as clickable controls (such as icons) within the work pane 306 to perform content modification tasks for a business document (or a section/subsection therein). This set of editing includes an Edit control 702, a Properties/Schedule control 704, a User Permissions control 706, a Cut control 710, a Delete control 712, a Move Up control 714, a Move Down control 716 and a Paste control 718. Of this set of controls, the Move Up control 714 and the Move Down control 716 perform the same rearrangement actions on hierarchy elements in the navigation pane 306 as their identically-named counterparts 530 and 532 and need not be explained here. The Properties/Schedule control 704, the User Permissions control 706, the Cut control 710 and the Delete control 712 will be discussed later in context of content scheduling, removing/deleting business documents, and configuring user access respectively.

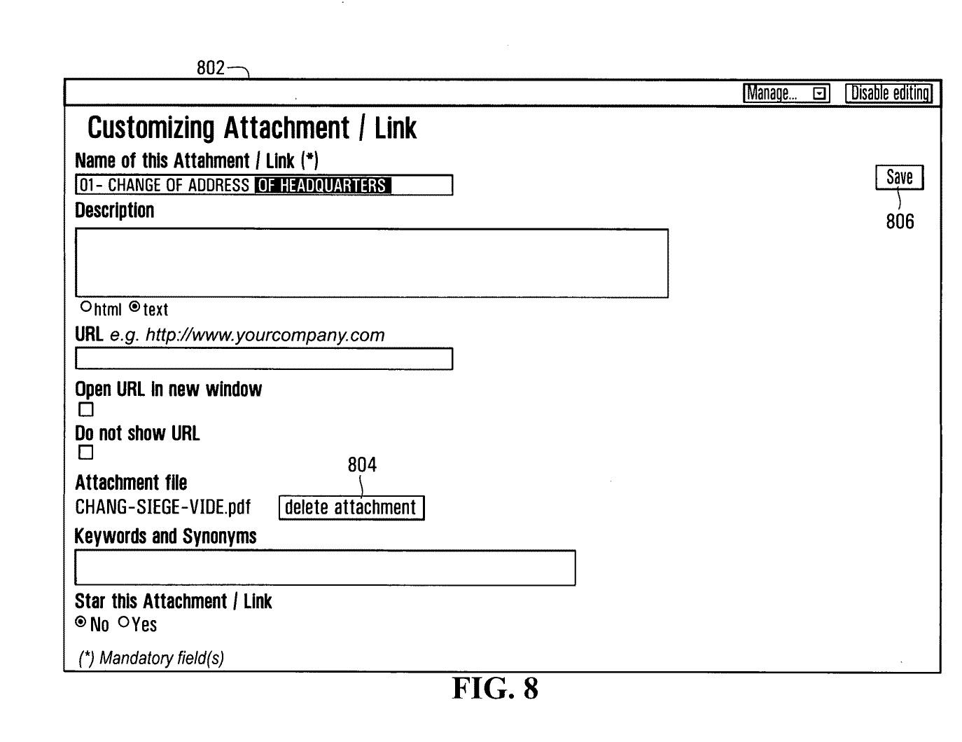

FIG. 8 shows a non-limiting example of a Customize Attachment/Link interface 802 generated by the GUI of the system in response to the Edit control 702 in the work pane 308 that appears when the business document to be updated during a content update is an attached computer-readable file (such as a PDF file). Many of the controls in this interface (such as the Name field) are identical to those described previously in FIG. 5 and need not be repeated here. To perform the content update, a user would use a Delete Attachment control 804 to remove the attachment (in this case, a PDF file) representing the old version of the content in the business document from the system. Once the old version of the file is removed, other controls (not shown) appear in the interface 802 that allow a file representing the new version of the content in the business document to be made accessible via the system, and the new content for the business document is saved to the system using a Save control 806.

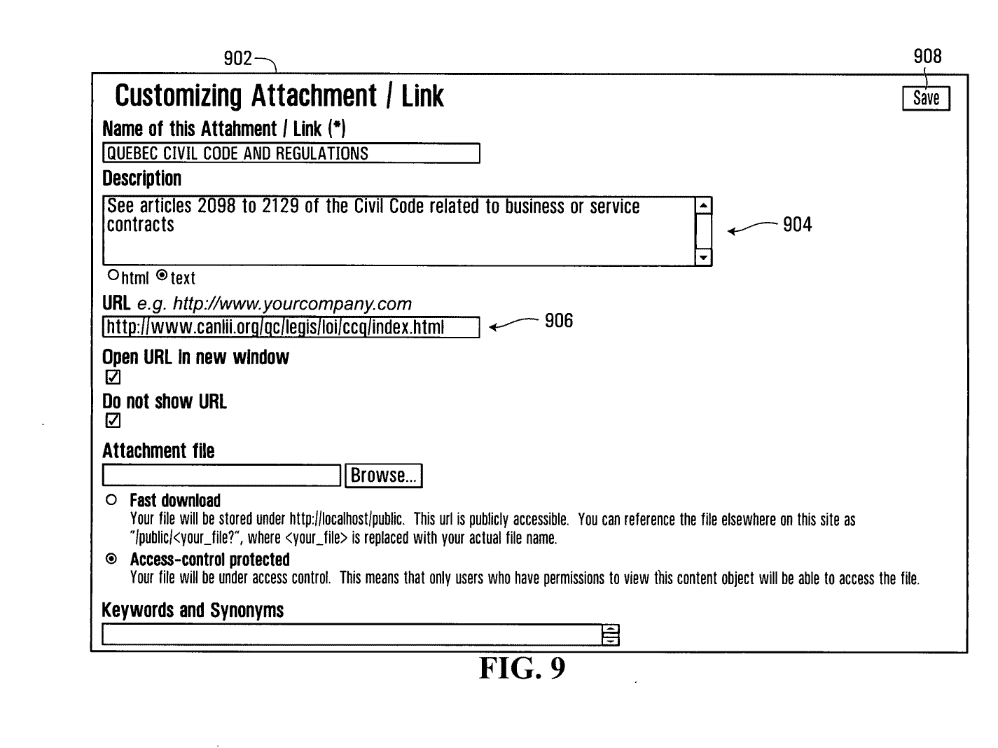

FIG. 9 shows a non-limiting example of a Customize Attachment/Link interface 902 generated by the GUI of the system. The interface 902 is similar to the interface 802, but is for a business document with some inline text in a Description field 904 and a link to external content in a URL link field 906. Assume that in this case, the content to which the document refers to has changed URL and the articles listed in the description have changed accordingly. In this case, the user would perform a content modification by doing the following:
Update the link to the external content in the URL link field 906; and
Modify the article numbers in the description through the Description field 904.

Once the user is satisfied that the modification represents the correct updated content for the business document, they use a Save control 908 to update the description and URL for the business document within the system.

It is conceivable that a business document could be added to the system that is not meant to be visible until a later time. Examples of such documents could be press releases and product announcements, which are typically created in advance of their publication and distribution. As a result, there is a need to schedule a starting time period when a business document is becomes available for viewing, as well as an ending time period where a business document is considered expired and is unavailable for viewing, although it remains within the system. To accommodate this need, the system of hierarchical organization of business documents provides scheduling functionality for business documents made accessible through the system. The Properties/Schedule control 704 in the set of editing tools identified in FIG. 7 provides access to this functionality.

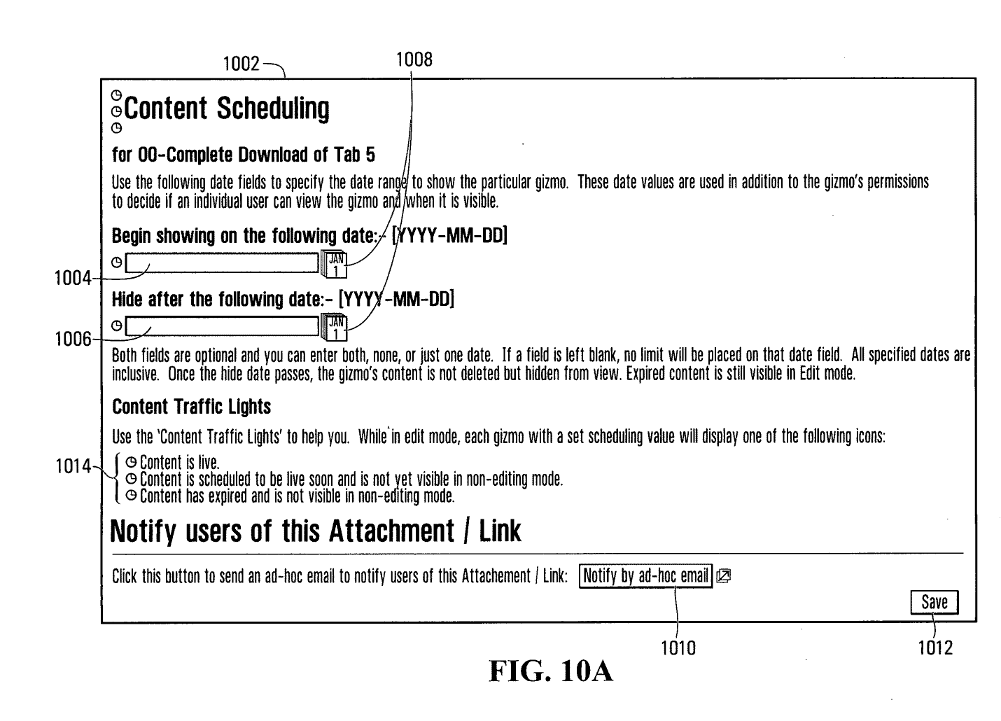

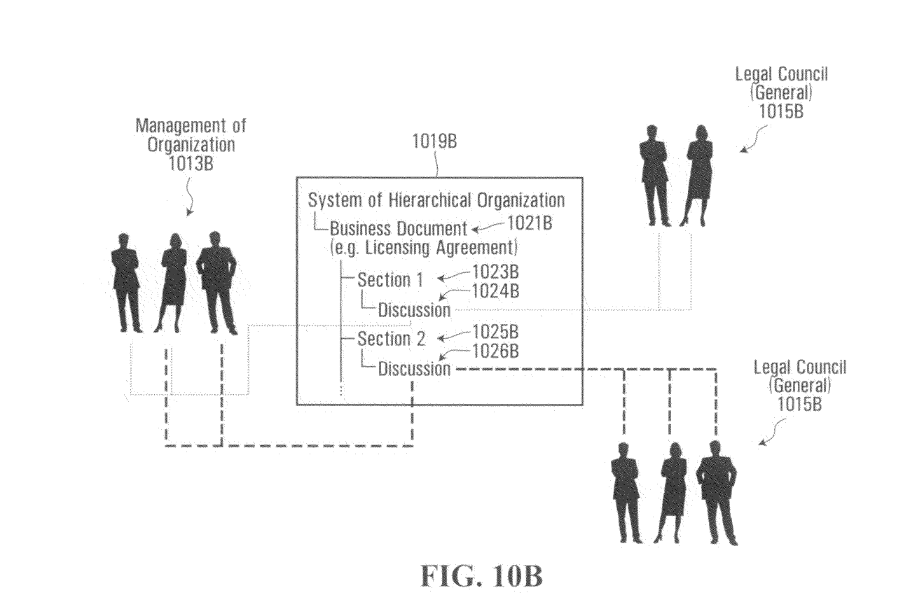

FIG. 10A shows a non-limiting example of a Content Scheduling interface 1002 generated by the GUI of the system in response to the use of the Properties/Schedule control 704. The interface 1002 contains a Start Date field 1004, an End Date field 1006, a set of Calendar controls 1008, a Notification Email control 1010 and a Save clickable control 1012. To set the time period during which a business document (or section/subsection thereof) is available for viewing, the user sets the date when the availability of the company begins in the Start Date field 1004 and the date when the availability of the business document ends in the End Date field 1006. The user can specify the starting and ending dates manually in the fields 1004 and 1006 or use the Calendar controls 1008 to choose these dates from an on-screen calendar (not shown). Once the starting and/or ending dates for the business document's availability are set, the Save clickable control 1012 is used to update the system and apply the content scheduling rules set in the interface 1002 to the business document.

It should be understood that the Start Date field 1004 and the End Date field 1006 can be used independently of each other; that is, a user can set a start date for a business document without an end date and vice-versa. A date entered in the Start Date field 1004 without a corresponding entry in the End Date field 1006 means that the business document becomes available at the date specified but never expires. Conversely, a date entered in the End Date field 1006 without a corresponding entry in the Start Date field 1004 means that the business document is immediately available but will expire at a given future point in time.

Once the content scheduling rules set in the interface 1002 are applied to the associated business document, a set of red, yellow and green “traffic light” icons 1014 are used elsewhere in the system to indicate the status of the document. These icons indicate the following:
The green icon indicates business documents and/or other content that is currently available;
The yellow icon indicates business documents and/or other content that is scheduled to become available at some point in the future (i.e. the date in Start Date field 1004 is greater than the current date); and
The red icon indicates business documents and/or content that is past its expiry date and is unavailable (i.e. the date in the End Date field 1006 is less than the current date).

It is worth noting that the availability of a document for viewing depends on its availability status (as indicated by the set of “traffic light” icons 1014), the user permissions applied to the business document and the status of the user on the system. Although the concepts of user access, confidentiality and permissions will be discussed later, assume in a non-limiting example that a business document that is meant to be confidential to executives of the company is added to the system and its permissions are configured to only allow certain executives to view the document. Further assume that the document is scheduled to become available for a defined time period of one week. In this case, once the document becomes available, it will only be visible to those users (i.e. executives) identified as having permission to view it; no other employees will be able to see it during the week when it is available to be viewed. Combining content scheduling with permissions helps to ensure that only those with the necessary prerequisites can view a business document when it is scheduled as available.

The Notification Email control 1010 on the interface 1002 can be used to notify a user (or set of users) when a business document becomes available and/or expires. This functionality allows interested parties to be notified when a business document becomes available for viewing. For example, assume that a business document for a press release is added to the system but it is not scheduled to be visible until one week from today. Further assume that the Notification Email control 1010 is set up to alert internal users (such as marketing department employees) and external users (such as journalists in the trade press) once the business document becomes available. Once the publication date for the press release is reached, the system sends out a notification email to the addresses identified earlier to notify them that the press release is available for viewing.

In practise, content management activities (including content update or content modification) for business documents often result from the input of other people within an organization. These activities may be a result of information from people outside of the organization who have identified information that should be updated within a business document. For example, technical support staff as well as the end-users of a software application may find errors which should be corrected in future versions in a product's User guide that is accessible through the system.

As a result, there is a need to collect user feedback about the content contained within a business document accessible through the system. To accommodate this need, the system of hierarchical organization of business documents provides functionality to collect information through an attached discussion. The term “discussion” may refer to a forum whereby users can read, submit and/or reply to messages left by other users. This provides users with an opportunity to annotate a business document, providing information such as errors or mistakes, tips and tricks, workarounds to problems and suggestions for how to improve the document in future versions, among others.

Discussions also allow multiple contributors to review and submit comments about a business document. In a non-limiting example, assume that an organization uses outside counsel to provide legal advice with respect to the drafting of legal documents, such as contracts and agreements. Further assume that individuals in outside counsel have access to the system through user accounts that are registered with the system. Thus, as shown on FIG. 10B, the system may act as an intermediary 1019B between a business' internal resources such as management personnel 1013B and external resources such as general legal counsel 1015B and specialized legal counsel such as Intellectual Property counsel 1017B. Other non-counsel external resources may use the system in such a manner as well. Thus, through use of the system as a common repository for file data, the multiple parties can share information/documents using the system. Discussions allow exchanges regarding the shared information/documents. In FIG. 10B, access to different discussions is illustrated with different styles of dotted lines. It is to be appreciated that although the system is shown here as being used as an intermediary 1019B between internal resources and external resources, it may act as an intermediary between two external resources, for example as a virtual data room used between two outside counsels in litigation.

Moreover, further assume that an organization is drafting a technology licensing agreement in consultation with outside legal counsel. By attaching a discussion to each section (which may be down to the individual clause level) of the licensing agreement, the management of the organization can collaborate with lawyers serving on its outside legal counsel in drafting the specific terms and conditions for the overall agreement.

Because discussion(s) for the licensing agreement are maintained in an electronic form through the system and are available for all participants to see, it is worth noting that regular communication and information sharing may be fostered between parties who may not have otherwise communicated. In addition, a discussion provided through the system allows asynchronous communication to occur between different parties, allowing participants (i.e. managers or members of outside legal counsel) to contribute to the discussion regardless of where they are located or the time of day.

In another non-limiting example showing a variant use of the invention, assume that a technical writer creates a business document for a User guide of an upcoming software application. The technical writer attaches a discussion for the document to collect feedback from related reviewers, such as developers, product managers and technical support engineers. The use of the discussion allows the reviewers to submit their individual review comments to the technical writer, as well as benefit from information submitted by other reviewers through their comments. For example, assume that a technical support engineer posts a message to the discussion identifying an error in a troubleshooting procedure in the User guide. Because everyone sees the message, the technical writer updates their guide to reflect the correct information and the software developer can log a bug to address the underlying condition that caused the troubleshooting procedure to be required in the first place.

Content management tasks that can be performed in the system of hierarchical organization of business documents also include those involving the removal and/or the deletion of business documents from the system. In the context of content management, the term “cutting” or “removing” business documents refers to a process by which a business document (or part thereof) is temporarily removed from the hierarchy in order to transfer it to another category or level of the hierarchy. In contrast, the term “deletion” refers to a process in which a business document is permanently removed from the hierarchy.

Cutting business documents is usually performed if a business document was added to the wrong category or sub-category and/or if some reorganization or consolidation of categories within the hierarchy is occurring. In a non-limiting example, assume that the hierarchy of HR-related business documents is as follows:

```
Human Resources (root category)
  Hiring Agreements (Level 2)
    Employee 1 (Level 3)
    . . .
    Employee N (Level 3)
  Employee Contracts (Level 2)
    Full-time Employees (Level 3)
      Employee 1 (Level 4)
      . . .
      Employee N (Level 4)
    Contract Employees
      Employee 1 (Level 4)
      . . .
      Employee N (Level 4)
    Part-time Employees (Level 3)
      Employee 1 (Level 4)
      . . .
      Employee N (Level 4)
  Termination Agreements (Level 2)
    Employee 1 (Level 4)
    . . .
    Employee N (Level 4)
```

However, the HR department has decided that this hierarchical organization is too unwieldy and should be structured as follows:

```
Human Resources (root category)
  Employees (Level 2)
    Employee 1 (Level 3)
      Hiring Agreement (Level 4)
      Employment Contract
      Termination Agreement
    . . .
    Employee N (Level 3)
      Hiring Agreement (Level 4)
      Employment Contract
      Termination Agreement
```

In this case, existing business documents must be transferred by first removing them from the old hierarchy, and then placing them in the appropriate category in the new hierarchy. Although the Move Up control 530 and the Move Down control 532 in the navigation pane 306 can be used to reposition a business document within its category, these controls cannot be used to promote or demote a document outside of its category. As a result, there is a need to transfer business documents among different categories (i.e. levels) of the hierarchy.

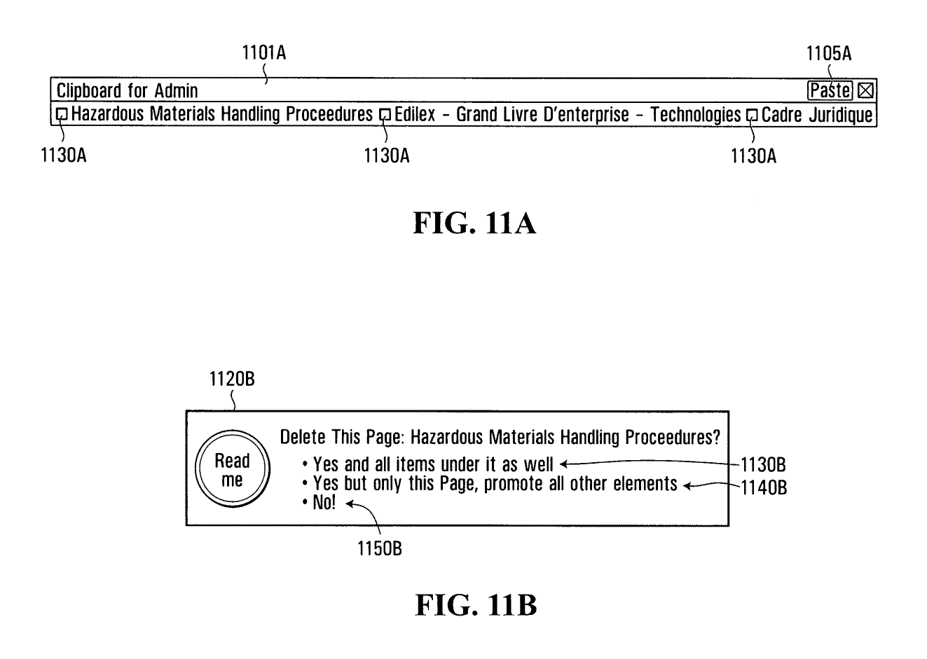

To accommodate this need, the system of hierarchical organization of business documents provides functionality to remove a document from one position in the hierarchy and transfer it to another position. This task is performed using the Cut control 710 and the Paste control 718 that were introduced in FIG. 7, as well as a temporary storage area called a Clipboard. FIG. 11A shows a non-limiting example of a Clipboard interface 1101A generated by the GUI of the system in response to the use of the Cut control 710. The Clipboard interface 1101A contains clickable controls (such as checkboxes or radio buttons) 1103A that represent business documents currently stored and awaiting transfer within the hierarchy. The functionality of the Paste control 1105A is identical to that of the control 718 and will be discussed below.

In order to transfer a business document between different categories in the hierarchy, a user first displays the document to be transferred and then uses the Cut control 710 to remove it from the hierarchy and transfer it to the Clipboard. The Clipboard interface 1101A is updated, with removed document appearing as one of the clickable controls 1103A. Next, the user navigates to the category or sub-category in the hierarchy under which the removed business document should be placed, and then the Paste control 718 (or 1105A) is used to transfer to the business document from the Clipboard interface to its new location in the hierarchy.

Although specific policies for the management of business documents in the system is left to the discretion of the organization, the following two general rules are often recommended to guide the formulation of such policies:
Only one copy of a business document should exist within the system at a time; and
Business documents that do not provide utility should be permanently removed from the system.

The first rule ensures that only one copy of a business document exists within the system, so users do not have to wonder if they are have found (or are updating) the ‘right’ version of a document. If this rule is ignored, it is likely that multiple copies of the same document could exist within the system under entirely different categories. In such a situation, performing content management tasks becomes difficult since even the most minor change would needs to be replicated across multiple copies of a document.

In a non-limiting example, assume that a copy of each employee's employment contract is stored in an HR category and a Legal Contracts category. Further assume that the organization decides to update their existing ‘no-compete’ clause (i.e. a clause that forbids the employee from working for the competition for a specified period of time) to their employment contracts. However, the content modification must be performed twice for each employee as there are two copies of this document in the system.

The second rule ensures that all business documents accessible through the system are providing some utility to users. Removing documents that are not used or needed anymore frees space in the system for new business documents to be added.

As a result of these factors, there is a need to delete business documents from the system. To accommodate this need, the system of hierarchical organization of business documents provides functionality to delete business documents that may not be needed anymore. This task is performed using the Delete control 712 that was introduced in FIG. 7. Because the Delete control 712 permanently deletes a business document from the system, a confirmation message appears each time this control is used to provide a last opportunity for the user to cancel the operation and leave the business document in the system.

FIG. 11B shows a non-limiting example of a Confirmation interface 1120B generated by the GUI of the system in response to the use of the Delete control 712. The Confirmation interface 1120B contains clickable control (such as hyperlinks) including a Delete control 1130B, a Delete and Promote control 1140B and a Cancel control 1150B.

The Cancel control 1150B allows the user to cancel the operation and leave the business document intact. The clickable controls 1130B and 1140B allow the deletion of the business document to proceed, but provide a degree of control over how the business document is deleted from the system. The Delete control 1130B deletes the selected business document as well as any associated subsections below the selected document. In contrast, the Delete and Promote control 1140B deletes only the business document while any subsections that exist below this document are promoted one level up in the hierarchy.

In a specific but non-limiting example, assume that the hierarchical organization of environmental-related business documents in the system is as follows:

```
Environment
  Regulated Activities
  Hazardous Materials
  Emergency Plans
    Fire Evacuation Plan
      Fire Evacuation Plan - Office
      Fire Evacuation Plan - Plant
    Hazardous Materials Evacuation Plan
      Hazardous Materials Evacuation Plan - Office
      Hazardous Materials Evacuation Plan - Plant
    Terrorism Evacuation Plan
      Terrorism Evacuation Plan - Office
      Terrorism Evacuation Plan - Plant
```

Further assume that after review, the organization has decided to get rid of the Hazardous Materials Evacuation Plan business document since its content is similar enough to the other evacuation plans that it is deemed unnecessary. To do this the Delete control 710 is used on the Hazardous Materials Evacuation Plan business document and the Confirmation interface 1120B appears.

If the Delete control 1130B is used, the Hazardous Materials Evacuation Plan document and its two constituent sections for the individual office and plant evacuation plans are deleted and the resulting hierarchical organization of environmental-related business documents in the system appears as follows:

```
Environment
  Regulated Activities
  Hazardous Materials
  Emergency Plans
    Fire Evacuation Plan
      Fire Evacuation Plan - Office
      Fire Evacuation Plan - Plant
    Terrorism Evacuation Plan
      Terrorism Evacuation Plan - Office
      Terrorism Evacuation Plan - Plant
```

On the other hand, if the Delete and Promote control 1140B is used, the Hazardous Materials Evacuation plan document is deleted, but its constituent sections are promoted to produce the following hierarchical organization of environmental-related business documents:

```
Environment
  Regulated Activities
  Hazardous Materials
  Emergency Plans
    Fire Evacuation Plan
      Fire Evacuation Plan - Office
      Fire Evacuation Plan - Plant
    Hazardous Materials Evacuation Plan - Office
    Hazardous Materials Evacuation Plan - Plant
    Terrorism Evacuation Plan
      Terrorism Evacuation Plan - Office
      Terrorism Evacuation Plan - Plant
```

This allows the company to retain the individual evacuation plans in order to reorganize them under the Hazardous Materials sub-category, as shown in the following hierarchy:

```
Environment
  Regulated Activities
  Hazardous Materials
    Hazardous Materials Evacuation Plan - Office
    Hazardous Materials Evacuation Plan - Plant
  Emergency Plans
    Fire Evacuation Plan
      Fire Evacuation Plan - Office
      Fire Evacuation Plan - Plant
    Terrorism Evacuation Plan
      Terrorism Evacuation Plan - Office
      Terrorism Evacuation Plan - Plant
```

A business document that is made accessible through the system can have permissions assigned to it to ensure its confidentiality, as well as protect it against intentional or unintentional modification and/or removal. Although these protections can be enforced, it is still conceivable that a business document meant to be confidential ends up publically available and/or someone unintentionally or maliciously alters or removes a business document from the system. Non-limiting example of this event include a press release that is “leaked” early because the person who added it forgot to use the content scheduling functionality, and/or a sales contract that is intentionally deleted from the system by a disgruntled salesperson due to the termination of their employment.

Upon the discovery of such an event, an organization typically instigates an investigation to determine how the event occurred and whether it resulted of an unintentional error or was intentionally planned. As a result, there is a need to audit events relating to business documents, including content management events. To accommodate this need, the system of hierarchical organization of business documents provides functionality to collect and organize information showing the actions relating to business documents and/or the users involved with their management. The term “event” may refer to an action performed by a user in the system, such as adding a business document to a hierarchy. In a non-limiting definition, an Event Log is a compiled list of actions relating to business documents undertaken by users in the system. The Event Log can be filtered to show events, such as:
All actions performed by a specific user;
All users who performed a specific type of action (such as a content modification); and/or
All users and actions relating to a specific function of the system (such as logins or site modifications).

The types of events that can be identified and filtered through the Event Log that are listed above constitute elements in a non-exhaustive list as other possibilities remain and fall within the scope of the invention.

Although the Event Log can be used for auditing events, it may also be used to troubleshoot system performance issues. As a result, access to the Event Log is provided through a System Configuration interface that is restricted to certain users, typically to system administrators responsible for the maintenance of the system in the organization. FIG. 12 shows a non-limiting example of a System Configuration interface 1202 generated by the GUI of the system that is available to system administrators. The System Configuration interface 1202 includes a clickable control to access the Event Log 1204, as well as a set of system usage statistics 1206.

FIG. 13 shows a non-limiting example of an Event Log interface 1302 generated by the GUI of the system in response to the usage of the clickable control for the Event Log 1204. The Event Log interface 1302 includes a username search field 1304, a class search field 1306, an object search field 1308, a clickable control (such as a button) used to initiate searches 1310, an Event navigation menu 1312, and an Event Log list 1314.

When a user first accesses the Event Log interface 1302, the Event Log list 1314 shows all events that have occurred in the system up to that point in time as “pages” organized chronologically within the Event navigation menu 1312. Accessing a page through Event navigation menu 1312 shows the events for this time period displayed as individual rows within the Event Log list 1314 through which the user can view past events. Each event in the Event Log list 1314 contains a Timestamp field 1320, a Username field 1322, an Operation field 1324, an Object Class field 1326, and an Object Name field 1328.

Although the user may use the Event Navigation menu 1312 to find past events and view their information in the Event Log list 1314, they are also provided with certain search tools to find events associated with specific users, specific types of objects and/or specific actions, as identified below:
The username search field 1304 can be used to find events associated with a specified user;
The class search field 1306 can be used to find events associated with a certain type of object within the system, such as the system's portal (UI); and/or
The operation search field 1308 can be used to find events associated with certain types of operations, such as downloading files, editing content or changing permissions.

To use these search tools, a user would enter the username, object type and/or operation type into its respective search field and then use the clickable control 1310 to initiate a search of logged events. The system finds all logged events corresponding to the criteria provided in the search tools 1304, 1306 and/or 1308 and updates the Event Log list 1314 to display only those events. In this way, the Event Log can be used to audit events relating to business documents, including those events related to content management, such as content updates and modifications.

In a specific yet non-limiting example, assume that an organization producing automotive components uses the system for system of hierarchical organization of business documents to organize and maintain contracts with its suppliers. Due to an industry slowdown, the organization is forced to downsize and lays off a certain number of employees in order to stay in business. After these layoffs, other employees take over the supplier contracts of those who have been forced to leave. During this time, John Smith notices that the content in some of the supplier contracts that he has taken over have changed substantially. In some contracts, contract terms appear to have been deliberately modified in order to harm the organization, while clauses in other contracts now contain diatribes about the organization's employment policies. John escalates this issue to his superior, who recalls that the affected contracts were previously handled by Dave Lombard. Although Dave Lombard was a good salesman, he was also temperamental and known to become quite nasty when under pressure or behind on his sales quotas.

Suspecting that Dave Lombard is somehow involved, John meets with Lina Davies (the system administrator in the Information Technology department who is responsible for the system) to ask her to check Dave's actions within the system in the period around the layoff. Lina access the Event Log and performs a search using Dave Lombard's username in the username search field 1304 to identify all system events associated with him. By doing this, Lina is able to confirm John's suspicions that Dave Lombard was behind the changes to the supplier contracts, as well as identify other contracts that may have modified, but for which John is not responsible. After reviewing the contracts, both John and his superior ask Lina to restore the affected supplier contracts to their original content, which Lina is able to do. Lina, John and their superiors also inform HR of Dave Lombard's actions in the system in case they want to pursue the matter further.

The system of hierarchical organization of business documents simplifies the process by which a user is able to find a business document, navigate through its hierarchy and perform certain content management-related actions related to it, such as updating content in a certain contract clause or administrative regulation. However, it is conceivable that not all business documents (and the content contained within) are meant to be accessible to everyone. For instance, the individual employment contracts used in previous examples are examples of business documents that should remain confidential to those working in the Human Resources department of an organization.

As a result, there is a need to restrict access to certain types of business documents (and/or parts thereof) to a defined set of people. To accommodate this, the system requires that all users must have a user account registered in the system before they are allowed to access the hierarchical organization of business documents. Such user accounts identify the user to the system and allow permissions to be assigned to them either individually or as a group.

All registered user accounts are listed in a User Directory, which also provides filters by which user accounts (and their associated user information) can be located. For example, a user account registered with the system can be found based on the first or last name of its associated user, the nickname (a “shorthand” name that can be used in place of their first and last names), their email address as well as their group membership, which will be discussed later. The User Directory also provides a method by which the user accounts can be exported in a computer-readable file to an external software application, such as Microsoft Excel.

FIG. 14 shows one non-limiting example of a User Directory interface 1402 generated by the GUI of the system. The User Directory interface 1402 contains filters for First Name 1404, Family Name 1406, Nickname (or Screen name) 1410, Email address 1412 and Groups 1414. The User Directory interface 1402 also contains a clickable control 1408 that is used to initiate searches based on the information entered in the filters 1404, 1406, 1410, 1412 and 1414, as well as clickable controls 1416, 1418 and 1420 which are used to show accounts for users currently online, to register a new user account (which will be described in more detail later) and to export the list of accounts as a computer-readable file to an external software application, such as Microsoft Excel, respectively.

The User Directory 1402 also acts as the starting point of the process used to create new user accounts. User accounts for the system are typically created by a qualified representative of the organization, such as a system administrator. FIG. 15 is a block diagram representing the process used to create user accounts in the system. The initial step in this process, represented by step 1502, is to conduct a search of the User Directory 1402 for the user to check whether they already have a user account registered with the system using the filters identified previously. While step 1502 may be considered optional, it enhances overall system security by ensuring that each user is associated with only one user account. If the result of step 1502 identifies a user account already registered with the system for the user, they are advised of their account information in step 1520 and the process ends. Otherwise, the process of creating a new user account continues in step 1504, where the system administrator (or other qualified representative) chooses to register a new user account with the system by using the clickable control 1418.

FIG. 16 shows a non-limiting example of a Registration Form interface 1602 generated by the GUI of the system that may appear in the work pane 308 to register a new user account with the system. The Registration Form interface 1602 contains tools, including fields and clickable controls, needed to register the new user. Specifically, the interface 1602 contains a first name field 1610, middle initial field 1612 and last name field 1614 for the user, a nickname (or screen name) field 1616 for the user, a set of tools (such as radio buttons and/or fields) 1618 to identify the webpage that should appear to the user upon login, an email address field 1620 that is used to identify and communicate with the user, and two password fields 1622 and 1624 that stores the password used to identify the user. The Registration Form interface 1602 also includes a set of clickable controls 1604, 1606 and 1608 that are used to register the user, reset the fields in the form or cancel the user registration, respectively.

In step 1506, information for the user to be associated with the new user account is entered in the Registration Form interface 1602. This information may include:
The first name, middle initial and last name of the user in the fields 1610, 1612 and 1614, respectively;
The preferred nickname for the user in the field 1616; and
The home page (i.e. webpage) that should be displayed to the new user upon a successful login using the controls in the tool 1618.

It is worth noting that certain pieces of information (such as first and last name) are identified as mandatory and must be entered using their respective tools, while others are considered optional. The system will not register a user account that is missing mandatory information, but will register an account that is missing optional information. Any optional information that was missing at the time of registration (such as a nickname) can be added to the user account at a later time.

In step 1508, the logon credentials for the new account are entered in their appropriate controls on the work pane 308. Logon credentials may refer to the alphanumeric identifiers used by a user to access the system through their user account and specifically a user name and a password associated with the user account registered in the system. The email address is entered in the tool 1620 is used as the user name and the password for the user account is entered (and confirmed) using the fields 1622 and 1624 on Registration Form interface 1602. While the email address of the user must be used as the user name for the account, the password is left to the discretion of the system administrator (or qualified representative). However, the password used as part of the logon credentials must conform to a pre-determined minimum length and must also be confirmed by the system administrator/qualified representative before it will be accepted by the system. All identifiers needed for the logon credentials are required for user account to be registered; the system will not register a user account that is missing any part of the logon credentials.

In step 1510, the new user account is registered with the system via the clickable control 1604 on the Registration Form interface 1602 and the system confirms that the user account has been successfully registered and can now be used by the user. This information is communicated to the user in step 1520, which marks the end of the process.

Once the user account is registered, the user can log in to the system of hierarchical organization of business documents and begin using its functionality. FIG. 17 is a non-limiting example of a Login interface 1702 that may be displayed for logging in to the system. The Login interface 1702 contains fields for entering the login credentials to the system, specifically an email address field 1704 and a password field 1706, as well as a clickable control 1708 to submit the login credentials for comparison against login credentials already registered with the system. If the supplied login credentials in the field 1704 and the field 1706 match those in the system for a user account, the system accepts them and displays the main GUI that has been described in FIG. 3. Otherwise, the system cannot match the supplied login credentials to those registered for the system and the user is not permitted to access the system. In this way, access to the system remains restricted to those who have a registered user account.

Once the user account is registered, it is added to the list of users accessible through the User Directory and a corresponding user profile is created. The user profile for the account is accessible through a search of the User Directory. FIG. 18 is a non-limiting example of a user profile interface 1802 that may be generated by the GUI of the system in the work pane 308. The user profile interface 1802 may be used to initiate normal user management functions, such as editing user information and deleting a user account from the system. The user profile interface 1802 includes a Groups area 1808 that shows the groups to which the user currently belongs, while a clickable control 1810 allows the user to be added to (or removed from) available groups within the system. The groups identified within this interface 1802 may determine what business documents the user is able to access through the system, as well as the content management tasks they may be able to perform.

Although access to the system of hierarchical organization of business documents is limited by the requirement for a user account, a more granular form of user control can applied to business documents through the use of user permissions. User permissions refer to the extent of system functionality that is made available to a user (or set of users) at a certain given point in the hierarchy, such as to modify or add content to a section of a business document. User permissions can be applied to any element at any level of the hierarchy, including (but not limited to) categories/sub-categories, business documents and sections/subsections.

User permissions can be applied to individual users as well as groups. According to a non-limiting definition (and within the context of the system), a group refers to a set of users (or members) who collectively belong to the same organization or part thereof, such as a department. Organizing users into groups simplifies the process of assigning using permissions, as permissions for business documents can be assigned to both groups and individuals. When a group is assigned permissions to a business document (or part thereof) within the hierarchy, all members of the group are automatically granted the same permissions.

A user can also belong to more than one group, each of which may have different levels of permission to access business documents in the system. For example, assume the Chief Technical Officer (CTO) of an organization belongs to an Executive group that deals with management-level issues, a Strategy group that develops overall corporate strategy, and an IT group that includes everyone involved with providing and/or maintaining information technology within the organization. Further assume that the Executive and Strategy groups have access to a set of confidential business documents that are denied to members of the IT group. While the CTO is a member of the IT group (which is denied access to these business documents), he or she can still access these confidential business documents because of their membership in the other groups.

FIG. 19 shows a non-limiting example of a user permissions interface 1902 that may be generated by the GUI of the system to assign permissions for a particular hierarchy element (i.e. category, subcategory, business document, section, or subsection). The user permissions interface 1902 contains the following clickable controls to assign a prescribed level of permissions to pre-defined subsets of users, such as the “Owner” subset:
A View control 1910 to control who can view the hierarchy element;
An Edit control 1912 to control who can edit (modify) the hierarchy element, such as modifying the text of a contract clause or changing an attachment;
A Delete and Cut control 1916 to control who can remove the element from the hierarchy to place it elsewhere and/or delete it from the hierarchy entirely;
A Change Permissions control 1918 to control who can change the permissions applied to a hierarchy element; and
A Broadcast Message control 1914 to control which users have the ability to send emails about the hierarchy element to each other.

The user permissions interface 1902 also provides tools to add and/or remove groups and individual users to the Owner subset of users. Normally, this subset includes only the user(s) who created an element (such as a business document) within the hierarchy, and who are provided full control (including read/write/modify/delete and change permission rights) over it. Adding groups and individual users to the Owner subset expands the number of users who can update and change a category/subcategory, business document or section, subsection.

A Group control 1922 displays existing groups stored within the system while a clickable control 1920 allows the group to be added to the pre-defined Owner subset, thus inheriting their permissions. Individual users can also be added to the permissions assigned to the Owner subset: an email address field 1930, a full name field 1932 and a nickname/screen name field 1934 allow a user to locate and add an individual user account to the Owner subset.

FIG. 20 is a block diagram showing the process by which permissions are assigned to an element to pre-defined user subsets, groups and individual user accounts. The starting point for this procedure is the user permissions interface 1902. In step 2020, the minimum permissions needed to access and use functionality for viewing, editing, copying, deleting, changing permissions and sending broadcast messages are set using the controls 1910, 1912, 1914, 1916 and 1918. The term “minimum permissions” refers to the minimum user subset to which a user account must belong in order to access and use the system functionality. The table below shows the pre-defined user subsets ordered by rank to which the minimum permissions for system functionality can be set:

| User Subset Name | Description |
|---|---|
| Public Access | Anyone who is connected to the system, regardless |
| | of whether they are logged in or not. |
| Logged In | All users who are currently logged into the system |
| | via a user account. |
| Owner | User(s) who created the element in the system. |
| Site Owner | Users designated as site owners. |
| Admin | Users designated as System Administrators. |

In a specific and non-limiting example, assume that a Vacations policy section of the administrative handbook for the organization has recently been added to the system by an employee in the HR department. Further assume that the system is maintained on an internal network that is restricted to employees of the organization only. Because this section is meant to be accessible to all employees, the minimum permission for the View functionality is set to Public Access, but the minimum permissions for all of the remaining functionality (such as Edit and Change Permissions) are set to the Owner user subset. These minimum permission settings ensure that all employees will be able to view the Vacation policy section but not otherwise modify or remove it.

In step 2030, user groups are added to the Owner subset using the controls 1920 and 1922. In this step, a group of users to be assigned the same permissions as the Owner subset is selected using the Group control 1922. Once the group has been selected from the list, it is added to the Owner subset using the clickable control 1920. In this way, one or more groups can be assigned permissions equivalent to those assigned to the Owner user subset. This step is considered optional as it is possible to assign permissions without selecting groups beforehand.

Continuing the non-limiting example above, further assume that an HR Policy group exists for HR executives within the organization. Since members of this group should be provided with the ability to modify the vacation policy (such as by adding explanatory content or updating it with changes later), this group is selected using the Group control 1922 and then added to the Owner subset using the clickable control 1920.

In step 2040, individual user accounts are added to the Owner subset using the controls 1930, 1932 and/or 1934. In this step, the user accounts are identified by entering the user's email address to the email address field 1930, the user's full name to the full name field 1932 and/or their nickname to the nickname/screen name field 1934 and then initiating a search. In response, the system displays the user account(s) corresponding to the search terms entered in the fields 1930, 1932 and/or 1934. The user accounts to be added are selected and added to the Owner subset for the element using clickable controls (not shown). This step is also considered optional since it is possible to assign permissions without selecting individual user accounts.

Continuing the non-limiting example above, further assume that any changes to the text of the Vacation policy section may also be made by certain administrative assistants who assist the HR executives of the organization. To allow this, the user accounts for the trusted administrative assistants must be added to the Owners user subset in order that they may perform these tasks in the system. To do this, the email address of each of the trusted administrative assistants is entered into the email address field 1930 and a search initiated. The user account for the administrative assistant is selected from the results displayed by the system and the account is then added to the Owner subset. This process is repeated until the user accounts for all of the trusted administrative assistants have been added to the Owner subset.

In step 2050, the permissions are assigned using a clickable control 1940 on the user permissions interface 1902. The permissions are assigned to the element and the process ends. Continuing the previous non-limiting example, execution of this step would result in the following permissions being set for the Vacation policy section of the administrative handbook:
All users would be allowed to view the Vacation policy section (i.e. Minimum permission for View set to All Users).
The creator of the section (i.e. the original employee in the HR department), the HR policy groups and the trusted administrative assistants would be allowed to edit the Vacation policy section. (i.e. minimum permission for Edit set to Owner).
The creator of the section (i.e. the original employee in the HR department), the HR policy groups and the trusted administrative assistants would be allowed to cut and/or delete the Vacation policy section. (i.e. minimum permission for Cut/Delete set to Owner).
The creator of the section (i.e. the original employee in the HR department), the HR policy groups and the trusted administrative assistants would be allowed to change the permissions for the Vacation policy section. (i.e. minimum permission for Change Permissions set to Owner).
The creator of the section (i.e. the original employee in the HR department), the HR policy groups and the trusted administrative assistants would be allowed to send broadcast messages to each other about the Vacation policy section. (i.e. minimum permission for Broadcast Messages set to Owner).

The use of user accounts, groups and the assignment of user permissions allows the restriction of access to information accessible through system of hierarchical organization of business documents to be controlled. In this way, confidential information can be shared among only those users who have a genuine need to know without affecting the utility of the system to provide and disseminate non-confidential information to other users.

Although various embodiments have been illustrated, this was for the purpose of describing, but not limiting, the invention. Various modifications will become apparent to those skilled in the art and are within the scope of this invention, which is defined more particularly by the attached claims.

1. A graphical user interface implemented on a computer, comprising:
a. a first selection component allowing a user to select a root category among a plurality of root categories of a business documentation directory, each root category being associated with at least one business document class;
b. a second selection component associated to a particular one of the root categories, the second selection component allowing a user to select a descendent category among a plurality of descendent categories, each descendent category being associated with a business document sub-class that is within the document class of the selected root category;
c. a first visualisation component displayable upon selection of the particular one of the descendent categories to display individual document indicia, associated with respective documents within the business document sub-classes of the selected descendent category;
each document indicia including a document indicium control allowing the user to cause display of the respective document.

2. A graphical user interface as defined in claim 1, wherein the second selection component is presented to the user upon selection of a root category.

3. A graphical user interface as defined in claim 1, wherein the business documentation directory includes root categories selected from the group consisting of human resources documentation, and tax documentation.

4. A graphical user interface as defined in claim 1, wherein the business documentation directory includes root categories selected from the group consisting of research and development documentation and intellectual property documentation.

5. A graphical user interface as defined in claim 3, wherein the second selection component is associated to the human resources documentation root category and the plurality of descendent categories include descendent categories selected from the group consisting of employment contracts documentation, employee training documentation and health and safety documentation.

6. A graphical user interface as defined in claim 4, wherein the second selection component is associated to the intellectual property documentation root category and the plurality of descendent categories include descendent categories selected from the group consisting of patent documentation and trade mark documentation.

7. A graphical user interface as defined in claim 1, further comprising a second visualisation component displayable upon the selection of a given root category or descendent category to display a legal framework indicium associated with a legal framework related to the business document class or business document sub-class associated with the given root category or descendent category, the legal framework indicium including a legal framework indicium control allowing the user to cause the display of legal framework information.

8. A graphical user interface as defined in claim 7, wherein the legal framework indicium control allows the user to cause the display of a legal text.

9. A graphical user interface as defined in claim 8, wherein the legal framework indicium control allows the user to cause the display of an online version of a legal text.

10. A graphical user interface as defined in claim 8, wherein the legal framework indicium control allows the user to cause the display of a text selected from the group of labour law statutes and regulations associated with labour law statutes.

11. A graphical user interface as defined in claim 1, further comprising an online store visual component displayable upon selection of the particular one of the descendent categories to display individual template document indicia associated with respective template documents related to the business document sub-class of a selected descendent category, each template document indicia including a first template document indicium control allowing the user to cause the retrieval of the respective template document.

12. A graphical user interface as defined in claim 11, wherein each template document indicium further comprises a second template document indicium control allowing the user to cause the display of a template document preview showing at least a portion of the template document associated with the respective template document indicium.

13. A graphical user interface as defined in claim 11, wherein the first template document indicium control allows the user to cause the retrieval of the respective template document in a first language, and wherein each template document indicium further comprises a third template document indicium control allowing the user to cause the retrieval of the respective template document in a second language.

14. A graphical user interface as defined in claim 11, further comprising a transaction visual component displayable upon in response to action at the first template document indicium control allowing the user to complete a transaction in which the respective template document is retrieved.

15. A graphical user interface as defined in claim 14, wherein the transaction comprises a payment.

16. A system for organizing business documents comprising:
a. a business directory comprising a plurality of business documents, the business directory comprising:
i. a plurality of root categories each root category being associated with at least one business document class; and
ii. at least one set of descendent categories associated with a particular root category, each descendent category being associated with a business document subclass that is within the particular root category;
b. a first selection tool for allowing a user to select a root category from among the plurality of root categories, the selected root category being associated with a set of descendent categories from among the at least one set of descendent categories;
c. a second selection tool for allowing the user to select a descendent category from the set of descendent categories associated with the selected root category, the selected descendent category being associated with at least one business document from the plurality of business documents; and
d. a third selection tool for allowing the user to select a business document from the at least one business document associated with the selected descendent category, selecting the business document causing the display of the business document to the user.

17. A system as defined in claim 16, further comprising a plurality of legal framework presentation tool each legal framework presentation tool being associated with respective legal framework information.

18. A system as defined in claim 17 wherein each legal framework presentation tool is associated with a root category or descendent category, the respective legal framework information being related to the root category or descendent category associated with the legal framework presentation tool, and wherein each legal framework presentation tool is enabled only when the corresponding root category or descendent category is selected.

19. A system as defined in claim 17, wherein the legal information associated with each legal framework presentation tool comprises at least one legal text and wherein the legal framework presentation tool allows the user to select a legal text to view from the at least one legal text within the legal information.

20. A system as defined in claim 19, wherein the legal text comprises legal statutes or associated regulations.

21. A system as defined in claim 16, further comprising an online store for allowing the user to retrieve a template document from among a plurality of template documents within the online store.

22. A system as defined in claim 21, wherein the online store comprises a plurality of sections, each of the plurality of template documents belonging to at least one section.

23. A system as defined in claim 22, wherein the online store is presented to the user upon activation of an online store actuating control.

24. A system as defined in claim 23, wherein the online store actuating control is presented to a user upon selection of a root category or descendent category, the actuating control causing a specific section of the online store to be presented to the user, the specific section of the online store having at least one template document related to the selected root category or descendent category.
